(19) United States
(12) Patent Application Publication
(10) Pub. No.: US 2025/0231522 A1
(43) Pub. Date: Jul. 17, 2025

(54) ELECTROPHOTOGRAPHIC MEMBER, ELECTROPHOTOGRAPHIC PROCESS CARTRIDGE AND ELECTROPHOTOGRAPHIC IMAGE FORMING APPARATUS, AND IONIC CONDUCTING AGENT

(71) Applicant: CANON KABUSHIKI KAISHA, Tokyo (JP)

(72) Inventors: TAKASHI KOYANAGI, Shizuoka (JP); SOUYA YAMANE, Shizuoka (JP); MASAKI YAMADA, Shizuoka (JP)

(21) Appl. No.: 19/002,362

(22) Filed: Dec. 26, 2024

(30) Foreign Application Priority Data
Jan. 15, 2024 (JP) 2024-003873
Aug. 19, 2024 (JP) 2024-137910

(51) Int. Cl. G03G 21/18; G03G 15/08

(52) U.S. Cl. CPC G03G 21/1814; G03G 15/0808

(57) ABSTRACT

An electrophotographic member comprising: a conductive substrate; and a conductive layer on the substrate, in which the conductive layer comprises a first resin and a second resin, the first resin is a resin having at least one selected from the group consisting of an urethane bond, an ether bond, and an aromatic ring, and the second resin comprises a (meth)acrylic resin having a structure expressed by the following formula (1), and a structure expressed by the following formula (2).

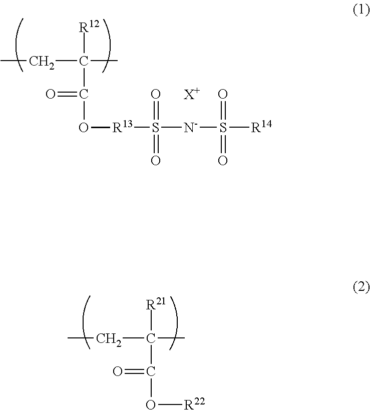

### BACKGROUND OF THE INVENTION

### Field of the Invention

The present disclosure relates to an electrophotographic member to be mounted in a device adopting the electrophotographic system. Further, the present disclosure relates to an electrophotographic process cartridge and an electrophotographic image forming apparatus using the electrophotographic member. Still further, the present disclosure relates to an ionic conducting agent.

### Description of the Related Art

In the electrophotographic image forming apparatus (which will be also referred to as an “electrophotographic apparatus”), an electrophotographic member including a conductive layer is used as, for example, a development member, a charging member, a toner supply member, or a cleaning member. The conductive layer of the electrophotographic member is controlled with an electric resistance value within the range of, for example, 1.0×10⁵ to 1.0×10⁹Ω. Further, the conductivity is required to be uniform throughout the whole member and to be stable with time. The conductive agents to be used for imparting the conductive layer with a prescribed conductivity include conductive particles such as carbon black, and an ionic conducting agent such as a salt compound of sulfonylimide anion and a metal cation.

The electron conductive roller including conductive particles such as carbon black added therein has an advantage that a change such as an increase in resistance due to the uneven distribution of conductive components even in electrification over a long term is less likely to be caused. However, on the other hand, conductive particles such as carbon black are difficult to evenly disperse, so that high-resistance or low-resistance segments may be generated locally. The ion conductive roller including an ionic conducting agent added therein can more reduce the unevenness of the electric resistance value due to the dispersion unevenness of the conductive agent as compared with an electron conductive roller, so that a high-resistance or low-resistance segment is less likely to be caused locally. For this reason, with a development roller, a developer can be developed evenly on a photosensitive member, and with a charging roller, uniform charging of the photosensitive member surface becomes possible.

Japanese Patent Application Publication No. 2004-163825 discloses a conductive roller formed by using a polymer composition including a non chlorine⋅non bromine type polymer as a main component, and including an anion having a fluoro group and a sulfonyl group.

### SUMMARY OF THE INVENTION

In recent years, an electrophotographic apparatus has been required to be able to keep high image quality and high durability even under more severe environment. The present inventors mounted the conductive roller described in Japanese Patent Application Publication No. 2004-163825 in an electrophotographic process cartridge as a development roller, and performed output of a large number of electrophotographic images under environment of a temperature of 0° C. using this process cartridge. As a result, generation of a ghost may be observed in the electrophotographic image with an increase in number of outputted paper sheets.

At least one aspect of the present disclosure is targeted for providing an electrophotographic member contributing to the stable formation of a high quality electrophotographic image under low temperature environment.

Further, at least another aspect of the present disclosure is targeted for providing an electrophotographic process cartridge contributing to the stable formation of a high quality electrophotographic image.

Still further, at least a still further aspect of the present disclosure is targeted for providing an electrophotographic image forming apparatus capable of forming a high quality electrophotographic image with stability.

Furthermore, at least a furthermore aspect of the present disclosure is targeted for providing an ionic conducting agent contributing to the effective dissociation of ions.

At least one aspect of the present disclosure provides an electrophotographic member comprising:
a conductive substrate; and
a conductive layer on the substrate, wherein
the conductive layer comprises a first resin and a second resin,
the first resin is a resin having at least one selected from the group consisting of a urethane bond, an ether bond, and an aromatic ring, and
the second resin comprises a (meth)acrylic resin having a structure expressed by a following formula (1), and a structure expressed by a following formula (2):

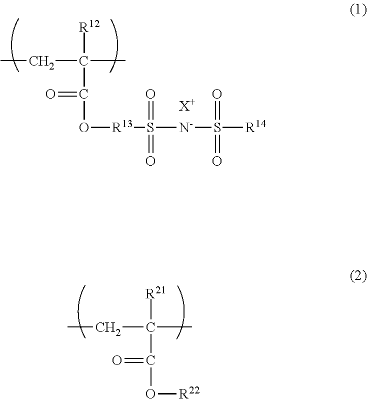

in the formula (1),
R¹² represents a hydrogen atom or a methyl group,
R¹³ represents a straight chain or branch alkylene group having 1 to 7 carbon atoms,
R¹⁴ represents
   a fluorine atom or
   a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms or an alicyclic hydrocarbon group having 5 to 6 carbon atoms.

Further, at least one aspect of the present disclosure provides an electrophotographic process cartridge configured detachably with respect to a main body of an electrophotographic apparatus, the electrophotographic process cartridge comprising the electrophotographic member of the present disclosure.

Furthermore, at least one aspect of the present disclosure provides an electrophotographic image forming apparatus comprising the electrophotographic member of the present disclosure as a development member.

In addition, at least one aspect of the present disclosure provides an ionic conducting agent comprising a (meth)acrylic resin having a structure expressed by a following formula (1), and a structure expressed by a following formula (2):

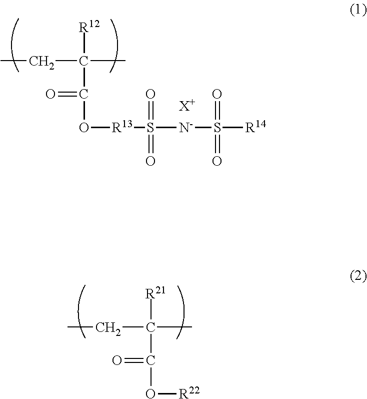

in the formula (1),
R¹² represents a hydrogen atom or a methyl group,
R¹³ represents a straight chain or branch alkylene group having 1 to 7 carbon atoms,
R¹⁴ represents a fluorine atom or a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms, or an alicyclic hydrocarbon group having 5 to 6 carbon atoms.

At least one aspect of the present disclosure can provide an electrophotographic member contributing to the stable formation of a high quality electrophotographic image under low temperature environment. Further, at least another aspect of the present disclosure can provide an electrophotographic process cartridge contributing to the stable formation of a high quality electrophotographic image. Still further, at least a still further aspect of the present disclosure can provide an electrophotographic image forming apparatus capable of forming a high quality electrophotographic image with stability. Furthermore, at least a furthermore aspect of the present disclosure can provide an ionic conducting agent contributing to the effective dissociation of ions. Further features of the present invention will become apparent from the following description of exemplary embodiments with reference to the attached drawings.

### BRIEF DESCRIPTION OF THE DRAWINGS

FIGS. 1A to 1C are each a schematic cross sectional view of one example of an electrophotographic roller in accordance with one aspect of the present disclosure;

FIG. 2 is a schematic block view of one example of a process cartridge in accordance with one aspect of the present disclosure;

FIG. 3 is a schematic cross sectional view of one example of an electrophotographic apparatus in accordance with one aspect of the present disclosure;

FIGS. 4A and 4B are each a schematic block view of a jig for evaluating the resistance value of a development roller;

FIG. 5 is an image view showing a mechanism in accordance with one aspect of the present disclosure;

FIG. 6 is a schematic cross sectional view of one example of a blade member in accordance with one aspect of the present disclosure; and

FIG. 7 is an explanatory view of the microsampling mass spectrometry.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ. When XX is a group, a plurality of constituents may be selected from XX, and the same applies to YY and ZZ.

In the present disclosure, the (meth)acrylic resin includes at least one selected from the group consisting of acrylic resin and methacrylic resin. Further, the (meth)acrylate includes at least one selected from the group consisting of methacrylate and acrylate.

The present inventors confirmed that in the output test of an electrophotographic image under low temperature environment using the conductive roller in accordance with Japanese Patent Application Publication No. 2004-163825, the electric resistance of the surface of the conductive roller immediately after generation of a ghost increased. From this, it has been presumed that the generation of a ghost is caused by the accumulation of electric charges at the conductive roller with an increase in number of outputted paper sheets of the electrophotographic image.

On the basis of such consideration, the present inventors conducted a close study, and as a result, they found that the following electrophotographic member contributes to the solution of the problem.

That is, an electrophotographic member according to an embodiment of the present disclosure is an electrophotographic member comprising:
a conductive substrate; and
a conductive layer on the substrate, wherein
the conductive layer comprises a first resin and a second resin,
the first resin is a resin having at least one selected from the group consisting of a urethane bond, an ether bond, and an aromatic ring, and
the second resin comprises a (meth)acrylic resin having a structure expressed by a following formula (1), and a structure expressed by a following formula (2):

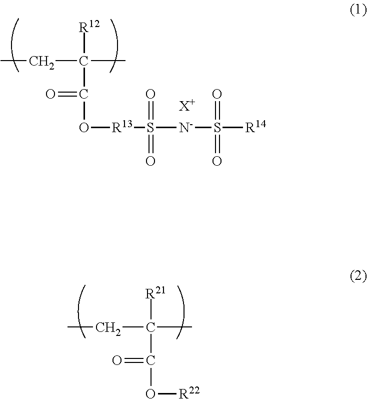

in the formula (1),
R¹² represents a hydrogen atom or a methyl group,
R¹³ represents a straight chain or branch alkylene group having 1 to 7 carbon atoms,
R¹⁴ represents
   a fluorine atom or
   a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms or an alicyclic hydrocarbon group having 5 to 6 carbon atoms.

The present inventors presume the reason why a ghost is difficult to generate also when the electrophotographic member in accordance with the foregoing configuration contributes to the formation of a large number of electrophotographic images under low temperature environment as follows.

Generally, a compound including chemical species with strong Lewis acidity or Lewis basicity forms a crystal (an ion crystal) due to the strong electrostatic interaction. In this case, the compound alone does not undergo ion dissociation. In order to cause such a compound to express the conductivity, an anion and a cation are required to be dissociated. To that end, for example, it is effective to achieve stabilization by addition of water and solvation of a cation. Thus, in order to dissociate a compound exhibiting a strong electrostatic interaction, it becomes necessary to stabilize the dissociated chemical species.

A metal cation has a smaller ion radius, and has higher mobility as compared with an organic cation. For this reason, it is expected as follows: even when polarization is caused by electrification upon applying a voltage thereto, release of the voltage results in quick and even dispersion. For this reason, such an increase in resistance as electrification deterioration is difficult to cause, which is preferable.

Japanese Patent Application Publication No. 2004-163825 relates to a technology of allowing a polyether-containing polymer or a polymer having a cyan group to coexist with a salt having a fluoro group and a sulfonyl group. In the document, the following is disclosed. The counter cation of the anion is lithium. Lithium is an ion species with a strong Lewis acidity, and exhibits a strong ion bonding property. For this reason, lithium is difficult to dissociate, and is low in conductivity alone. For this reason, cations generated upon dissociation are stabilized by a molecule having an electron-rich functional group, thereby promoting the dissociation, and improving the conductivity.

On the other hand, in the image output inspection performed by the present inventors, at the time when an image was outputted until the final stage under environment at low temperature such as 0° C., an increase in resistance of the development roller was observed. This can be considered due to the fact that the structure for stabilizing the cations is not in close spatial proximity because of the reduction of the molecular mobility due to low temperatures as one reason. Further, the following is considered to be the cause: even in close spatial proximity, not only the cations but also the whole ionic molecules are attracted, and hence, resultantly, the dissociation of ions is not caused.

For the solution of the problem, the conductive agent satisfying the following conditions (i) and (ii) is considered to be effective.
(i) the structure for stabilizing the cations is in close spatial proximity.
(ii) when the cations are attracted, anions remain there.

The present inventors conducted a study on the molecule structure of the compound satisfying the conditions (i) and (ii). As a result, they found that the inclusion of the following first resin and second resin in the conductive layer on the substrate can provide a preferable function.

(I) A resin (first resin) having at least one selected from the group consisting of a urethane bond, an ether bond, and an aromatic ring.

(II) A resin (second resin) comprising a (meth)acrylic resin having the structure expressed by the following formula (1) and the structure expressed by the following formula (2).

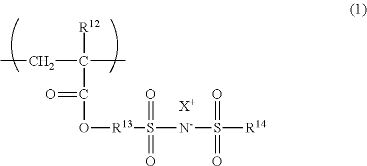

In the formula (1),
R¹² represents a hydrogen atom or a methyl group,
R¹³ represents a straight chain or branch alkylene group having 1 to 7 (preferably 2 to 6, and more preferably 3 to 5) carbon atoms,
R¹⁴ represents a fluorine atom or a straight chain or branch perfluoroalkyl group having 1 to 4 (preferably 1 to 2, and more preferably 1) carbon atom, and
X⁺ represents at least one selected from the group consisting of a lithium ion, a sodium ion, and a potassium ion.

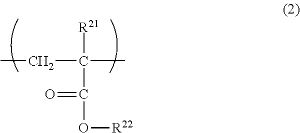

In the formula (2),
R²¹ represents a hydrogen atom or a methyl group, and
R²² represents a straight chain or branch alkyl group having 1 to 6 (preferably 2 to 5, and more preferably 2 to 4) carbon atoms, or an alicyclic hydrocarbon group having 5 to 6 (preferably 6) carbon atoms.

When the conductive layer includes the first resin and the second resin, a sulfonylimide anion, and a metal cation that are ion components, and the structure expected to have a cation stabilizing action are included in the conductive layer.

As the structure expected to have a cation stabilizing action, mention may be made of a urethane bond, an ether bond, and an aromatic ring. The oxygen atom (urethane oxygen) in the urethane bond has been increased in electron density due to the push-out effect of the unshared electron pair on nitrogen in the urethane bond. For this reason, an electron-poor cation species can be expected to be stabilized. Further, the oxygen atom in the ether bond has been polarized on the basis of the carbon-oxygen bond, so that the electron density around an oxygen atom has been increased. For this reason, contribution to the stabilization of the cation species is expected. Further, in an aromatic ring, the π electron cloud spreading on the aromatic ring is expected to contribute to the stabilization of the cation species (cation—π stacking effect).

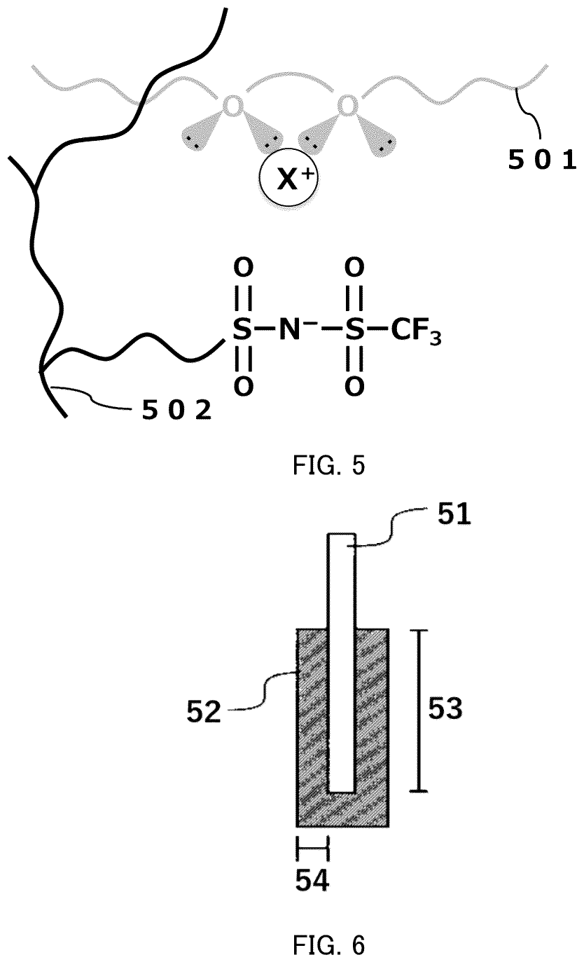

Further, the ion component is fixed on the tip of the structure of a second resin 502. For this reason, it is presumed as follows: when the structure expected to have the stabilizing action of the cation included in a first resin 501 (the ether bond in FIG. 5) attracts cations, anions will not be attracted, so that dissociation of ions is effectively achieved (FIG. 5).

### Ionic Conducting Agent

The ionic conducting agent in accordance with the present disclosure includes a (meth)acrylic resin having the structure expressed by the formula (1) and the structure expressed by the formula (2).

The number average molecular weight (Mn) of the (meth)acrylic resin having the structure expressed by the formula (1) and the structure expressed by the formula (2) is preferably 1000 to 100000 (more preferably 10000 to 50000) from the viewpoint of the balance between bleed-out and the compatibility.

In order to obtain a (meth)acrylic resin to be used for the ionic conducting agent in accordance with the present disclosure, the raw materials as described below can be used.

Sulfonylimide type ion compound having an unsaturated reactive functional group

Aliphatic (meth)acrylate

### Sulfonylimide Type Ion Compound

As the compound capable of forming the structure expressed by the formula (1), mention may be made of a sulfonylimide type ion compound having the unsaturated reactive functional group expressed by the following formula (1′).

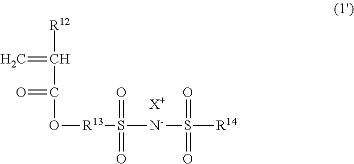

In the formula (1′), R¹². R¹³. R¹⁴, and X⁺ represent the same as those in the formula (1).

Specifically, for example, mention may be made of the sulfonylimide type ion compounds having the unsaturated reactive functional groups expressed by the following formulae C-1 to C-8.

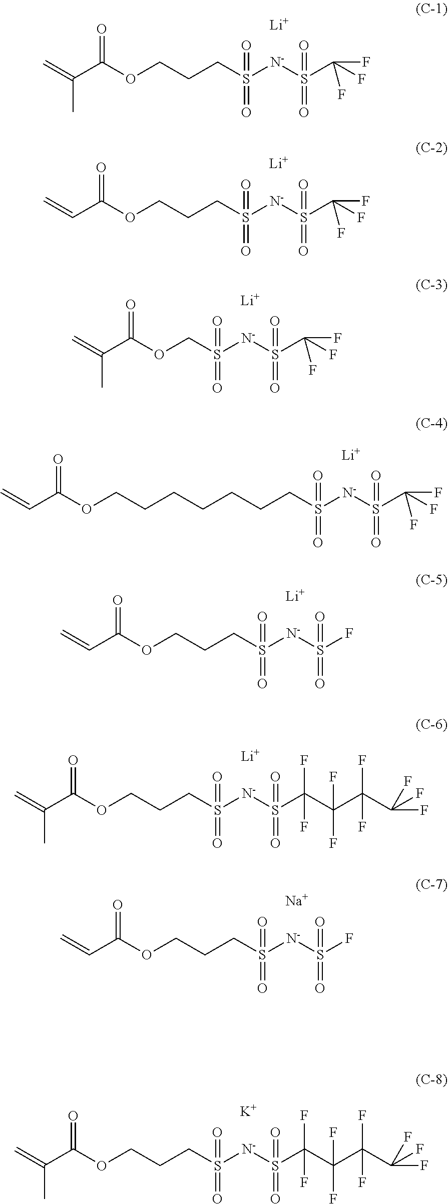

The ion compounds can be obtained from synthesis with a known method.

Aliphatic (meth)acrylate

Aliphatic (meth)acrylate can form the structure expressed by the formula (2). As aliphatic (meth)acrylate, for example, at least one selected from the group consisting of (meth)acrylate having a straight chain or branch alkyl group having 1 to 6 carbon atoms, and (meth)acrylate having an alicyclic hydrocarbon group having 5 to 6 carbon atoms can be used. Namely, the aliphatic (meth)acrylate expressed by the following formula (2′) can be used.

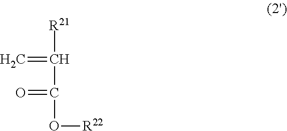

In the formula (2′), R²¹ and R²² represent the same as those in the formula (2).

Specifically, mention may be made of (meth)acrylate having an alkyl group such as methyl (meth)acrylate, ethyl (meth)acrylate, propyl (meth)acrylate, n-butyl (meth)acrylate, iso-butyl (meth)acrylate, t-butyl (meth)acrylate, n-pentyl (meth)acrylate, or n-hexyl (meth)acrylate; and (meth)acrylate having an alicyclic hydrocarbon group such as cyclopentyl (meth)acrylate, or cyclohexyl (meth)acrylate.

Out of these, at least one selected from the group consisting of methyl (meth)acrylate, n-butyl (meth)acrylate, iso-butyl (meth)acrylate, n-hexyl (meth)acrylate, and cyclohexyl (meth)acrylate is preferable. At least one selected from the group consisting of methyl methacrylate, n-butyl (meth)acrylate, iso-butyl (meth)acrylate, n-hexyl methacrylate, and cyclohexyl (meth)acrylate is more preferable.

Aliphatic (meth)acrylate may be synthesized by a known method, or a commercially available product may be used.

The sulfonylimide type ion compound having the unsaturated reactive functional group and the aliphatic (meth)acrylate as described above are allowed to react with each other. As a result, a (meth)acrylic resin having the structure expressed by the formula (1) and the structure expressed by the formula (2) can be obtained. For example, the second resin is a copolymerized product of aliphatic (meth)acrylate and a sulfonylimide type ion compound having an unsaturated reactive functional group. Alternatively, monomers having other unsaturated reactive functional groups may be used. The second resin is, for example, a resin different from the first resin.

In the (meth)acrylic resin having the structure expressed by the formula (1) and the structure expressed by the formula (2), the content of the structure expressed by the formula (1) is preferably 25 to 75 parts by mass, and more preferably 35 to 65 parts by mass for every 100 parts by mass of the total of the structure expressed by the formula (2).

When the mass ratio of the structure expressed by the formula (1) falls within this range, the structure expected to have the stabilizing action of the cations while including a sufficient amount of metal cations is also present in abundance. For this reason, the dissociation between ions is preferably caused, so that the ion conductivity can be expected to be improved.

The state after the reactions can be confirmed by, for example, analysis with known means such as pyrolysis GC/MS, FT-IR, and NMR.

### Cation

Examples of the cation X⁺ in the formula (1) may include at least one selected from the group consisting of a lithium ion, a sodium ion, and a potassium ion. Out of the cations, a lithium ion has a small ion radius, and a high mobility, and hence is particularly preferable.

### Electrophotographic Member

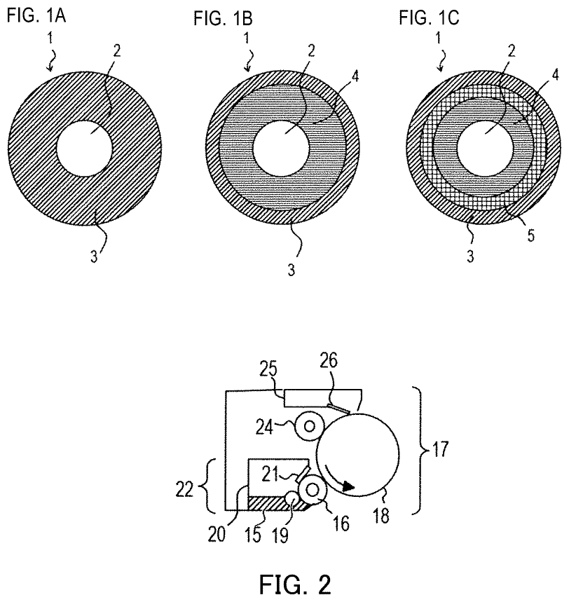

An electrophotographic member in accordance with one embodiment of the present disclosure has a conductive substrate, and a conductive layer on the substrate. As one example of the electrophotographic member, an electrophotographic member (electrophotographic roller) in a roller shape is shown in FIGS. 1A to 1C. An electrophotographic member 1 shown in FIG. 1A includes a conductive substrate 2, and a surface layer 3 consisting of a conductive layer including the first resin and the second resin provided at the outer circumference thereof. As shown in FIG. 1B, an elastic layer 4 may be provided between the substrate 2 and the surface layer 3. Further, the electrophotographic member 1 may have a 3-layered structure in which an intermediate layer 5 is arranged between the elastic layer 4 and the surface layer 3 as shown in FIG. 1C, or may have a multilayered structure including a plurality of intermediate layers 5 arranged therein. The conductive layer may be a resin layer consisting of a conductive resin.

Incidentally, the layer configuration of the electrophotographic member 1 is not limited to the configurations shown in FIGS. 1A to 1C. The electrophotographic member 1 may be configured as follows. For example, as with the configuration further having a surface layer on the substrate 2 and the conductive layer provided at the outer circumference thereof, a surface layer may be formed by stacking one or more layers of other resin layers or protective layers at the outer circumference of the conductive layer. Alternatively, a configuration having a conductive layer as the intermediate layer 5 is also acceptable.

Out of these, in order to more enhance the effect of the present disclosure, the electrophotographic member of the present disclosure is preferably configured such that the conductive layer is the surface layer 3 as shown in FIGS. 1A to 1C. Namely, it is preferably configured such that the conductive layer is present at the outermost layer of the electrophotographic member. Further, the electrophotographic member 1 preferably has the elastic layer 4.

The electrophotographic member in accordance with one aspect of the present disclosure can be used for, for example, a developer bearing member, a charging member, a developer supply⋅stripping member, a developer regulating member, and a cleaning blade. Particularly, the electrophotographic member can be preferably used as a developer bearing member, or a developer regulating member. Below, the configuration of the electrophotographic member in accordance with one embodiment of the present disclosure will be described in details.

### Conductive Layer

As described above, the conductive layer includes the first resin and the second resin. Further, the conductive layer preferably includes a binder resin, and the binder resin preferably includes the first resin. As described above, the first resin is a resin having at least one selected from the group consisting of a urethane bond, an ether bond, and an aromatic ring. Out of these, the first resin more preferably has at least one selected from the group consisting of a urethane bond and an ether bond, and more preferably has an ether bond.

Examples of the specific aspect include an aspect in which the conductive layer on the outermost surface of the electrophotographic roller includes a binder resin. This is for allowing the binder resin to express the metal cation stabilizing action as described previously. Further, from the viewpoint of the strength of the electrophotographic member or rubbing with other members, the first resin is preferably at least one resin selected from the group consisting of polyurethane, polyether, and polyphenylene, more preferably is polyurethane, and in particular preferably is a crosslinked urethane resin.

Although the thickness of the conductive layer has no particular restriction, it is preferably from 2.0 μm to 150.0 μm, and is more preferably from 5.0 μm to 100.0 μm. The thickness falling within this range results in a preferable rubber hardness, so that filming attendant upon toner stress or suppression of the set mark attendant upon long-term contact with the regulating member becomes more likely to be suppressed.

### Crosslinked Urethane Resin

A crosslinked urethane resin can be obtained by allowing polyol having a hydroxy group to react with an isocyanate compound, thereby forming a urethane group. The term “crosslinked” herein mentioned means that one or both selected from the group consisting of polyol and an isocyanate compound that are raw materials of the urethane resin have 3 or more reactive functional groups, and thereby have a three-dimensional network structure. Such a crosslinked urethane resin has excellent flexibility and high strength.

A urethane resin can be obtained from polyol and an isocyanate compound, and, if required, a chain extender. As polyol that is the raw material of the urethane resin, mention may be made of polyether polyol, polyester polyol, polycarbonate polyol, polyolefin polyol, and acrylic polyol, and mixtures thereof. Examples of the isocyanate compound that is the raw material of the urethane resin may include the following.

Tolylene diisocyanate (TDI), diphenylmethane diisocyanate (MDI), polymethylene polyphenylene polyisocyanate (polymeric MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethyl xylylene diisocyanate (TMXDI), and cyclohexane diisocyanate, and mixtures thereof.

Out of these, at least one selected from the group consisting of polymeric MDI and HDI is preferable.

Herein, the polymeric MDI is the mixture of a monomeric MDI and high-molecular weight polyisocyanate, and is expressed by the following formula (A). A sign “n” in the formula (A) is preferably from 0 to 4.

As the polymeric MDI, a commercially available product may be used. Mention may be made of MILLIONATE MR series (manufactured by Tosoh Corporation) such as MILLIONATE MR200 (trade name).

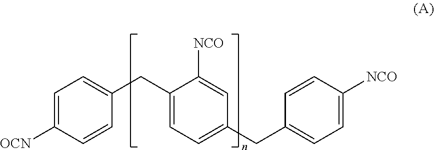

As the chain extenders of a given component, mention may be made of bifunctional low-molecule diols such as ethylene glycol and 1,4-butanediol, 3-methyl pentanediol, and trifunctional low-molecule triol such as trimethylolpropane, and mixtures thereof. Further, there may be used a prepolymer type isocyanate compound having an isocyanate group at the terminal, obtained by previously allowing the various isocyanate compounds and various polyols to react with each other with the isocyanate groups in excess over the hydroxy groups. Alternatively, as the isocyanate compounds, the materials obtained by blocking the isocyanate groups with various blocking agent such as methyl ethyl ketone (MEK) oxime may be used.

When any material is used, a urethane resin can be obtained by allowing polyol and an isocyanate compound to react with each other by heating. The urethane resin resulting from any one or both of polyol and the isocyanate compound having a branch structure, and having 3 or more functional groups becomes a crosslinked urethane resin, and is preferable.

Further, from the viewpoint of stabilizing the metal cation, the one in which any one or both of polyol or the isocyanate compound have an ethylene oxide structure or a propion oxide structure is particularly preferable.

### IPN Structure

Achieving such spatial environment that the first resin having the structure expected to have a cation stabilizing action, and the second resin capable of acting as an ionic conducting agent interact with each other more enhances the effect of the present disclosure. Namely, in a first region up to 0.1 μm in the depth direction from the outer surface (the surface opposite to the side opposed to the substrate) of the conductive layer, the first resin and the second resin are preferably included. In the first region, inclusion of the first resin and the second resin makes a metal cation exhibiting conductivity and the structure stabilizing the cation spatially close to each other. This can favorably enhance the conductivity at the outer surface of the conductive layer.

Further, it is particularly effective to allow the first resin and the second resin to configure Interpenetrating Polymer Network; IPN structure in the first region. The IPN structure denotes a structure in which the network structures of two or more resins are entangled with each other without being bonded with each other by covalent bonding. When the IPN structure is configured, the improvement of the conductivity is exhibited at the outer surface of the development member. For this reason, the resistance unevenness of the surface can be preferably suppressed. Accordingly, it becomes easier to suppress the image density non-uniformity at half tone, and the gradation anomaly due to charge-up of the member surface attendant upon image output.

By performing an impregnation treatment on an electrophotographic member precursor including the first resin using an impregnation treatment solution including a sulfonylimide type ion compound having an unsaturated reactive functional group expressed by the formula (1′), aliphatic (meth)acrylate expressed by the formula (2′), and a polymerization initiator, it is possible to form the IPN structure in the first region.

The IPN structure in the conductive layer can be confirmed by the shift of the glass transition point (Tg) of the resin configuring the IPN structure by the microsampling mass spectrometry.

Specifically, confirmation is performed by the following procedure.

The peak top temperature in the thermal chromatogram corresponding to the pyrolysis temperature of the resin can be considered to be shifted toward the higher temperature side when the resin configures the IPN structure than when the resin is present singly alone.

Therefore, it can be confirmed that the first resin and the second resin configure the IPN structure by the following fact: attention is focused on the first resin or the second resin in the conductive layer, and at before and after decomposition and removal of either resin, the peak top temperatures of the thermal chromatogram of the other resin are compared, so that the peak top temperature after decomposition is lower than that before decomposition. Herein, the thermal chromatogram is mass spectrum obtainable with the microsampling pyrolysis mass spectrometry.

The outline of the microsampling mass spectrometry will be shown below.

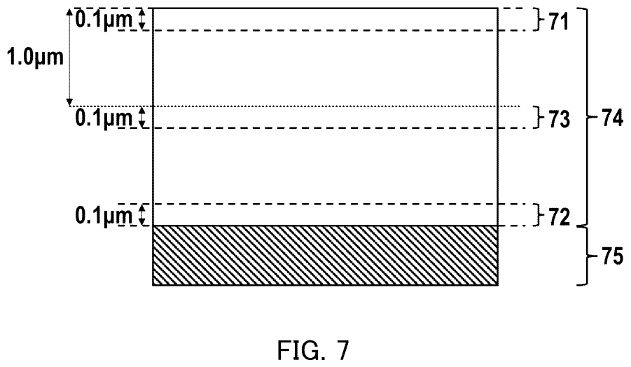

First, the region to be measured of the electrophotographic member is cut into thin pieces by a microtome, thereby preparing samples. As shown in FIG. 7, samples are prepared from 3 regions referred to as a first region 71, a second region 72, and a third region 73. The first region is the region to a depth of 0.1 μm from the outer surface of the conductive layer 74, the second region is the region with a thickness of 0.1 μm toward the outer surface from the inner surface (the surface on the side opposed to the substrate 75) of the conductive layer 74, and the third region is the region from 1.0 μm to 1.1 μm in the depth direction from the outer surface. Then, the sample obtainable from the first region is referred to as a first sample, the sample obtainable from the second region is referred to as a second sample, and the sample obtainable from the third region is referred to as a third sample.

A flake of 100 μm square and with a thickness of 0.1 μm is manufactured from each region of the conductive layer. For the measurement, for example, an ion trap type mass analyzer mounted on a gas chromatograph mass analyzer (trade name: Polaris Q, manufactured by Thermo Electron Co.) is used. The sample is fixed at the filament situated at the tip of the probe, and is directly inserted into an ionizing chamber. Thereafter, the sample is rapidly heated from room temperature up to a temperature of 1000° C. at a constant heating speed. The sample decomposed and evaporated by heating is ionized by irradiation with an electron beam, and is detected by a mass spectrometer. At this step, under conditions of a constant heating speed, the thermal chromatogram similar to the TG-MS (Thermogravimetry-simultaneous mass spectrometry) method, having the mass spectrum referred to as total⋅ion⋅chromatogram (TIC) is obtained. Further, the thermal chromatogram with respect to the fragment of a prescribed mass can also be obtained. For this reason, it is possible to obtain the peak temperature of the thermal chromatogram corresponding to the decomposition temperature of a desired molecular structure. The peak temperature of the thermal chromatogram is correlated with the crosslinked structure in the structure of a resin, and the peak temperature shifts to the higher temperature side with an increase in density of crosslinks.

The first resin and the second resin configuring the interpenetrating polymer network structure can be confirmed in the following manner. Namely, it is essential only that attention is focused on the first resin or the second resin, and the difference in peak temperature of the thermal chromatogram of the fragment derived from the other rein between before and after decomposition and removal of either resin. For example, it is essential only that the difference in peak temperature of the thermal chromatogram of the fragment derived from the second rein between before and after decomposition and removal of the first resin is confirmed.

The peak top temperature of the thermal chromatogram corresponding to the second rein measured from the first sample is referred to as A1 (° C.). Further, the peak top temperature of the thermal chromatogram corresponding to the second resin measured from the second sample obtained by decomposing the first resin included in the first sample is referred to as A2 (° C.). When the interpenetrating polymer network structure is formed, A1 and A2 satisfy the relationship expressed by the following formula (X).

$$A 1 > A 2 \qquad ( X )$$

As the method for decomposing the first resin, mention may be made of the pyridine decomposition method described later.

For the conductive layer, T1 and T2 preferably satisfy the relationship expressed by the following formula (3), where T1 (° C.) represents the peak top temperature of the thermal chromatogram corresponding to the first resin in the first region, and T2 (° C.) represents the peak top temperature of the thermal chromatogram corresponding to the first resin included in the second region with a thickness of 0.1 μm toward the outer surface from the inner surface of the conductive layer.

$$T 1 > T 2 \qquad ( 3 )$$

The formula (3) being satisfied can be confirmed by the microsampling mass spectrometry.

Further, the T1 and T2 preferably satisfy the following formula (4).

$$( T 1 - T 2 ) > 1. ( °C . ) \qquad ( 4 )$$

The formula (4) being satisfied can be confirmed by the microsampling mass spectrometry.

One of the functions achieved by the conductive layer is relaxation of the mechanical stress applied by the developer bearing member to a toner. For allowing such a function to be sufficiently exhibited, the conductive layer is preferably flexible. To that end, in the second region with a thickness of 0.1 μm toward the outer surface from the surface on the side opposed to the substrate of the conductive layer, the IPN structure is preferably not present. Alternatively, even when the IPN structure is present, for example, the IPN structure preferably has a weak degree of penetration of the second resin as compared with the IPN structure in the first region.

Therefore, the first region and the second region of the conductive layer preferably satisfy the relationship expressed by the formula (3), and in particular preferably satisfy the relationship expressed by the formula (4). Herein, T1 (° C.) denotes the peak top temperature of the thermal chromatogram corresponding to the first resin, measured from the sample sampled from the first region. T2 (° C.) denotes the peak top temperature of the thermal chromatogram corresponding to the first resin, measured from the sample sampled from the second region.

The values of T1 and T2 can be adjusted by the concentration of the treatment solution, the UV irradiation intensity, and the like.

Further, the T1, the T2, and T3 preferably satisfy the relationship expressed by the following formula (5) and the relationship expressed by the following formula (6) where T3 (° C.) represents the peak top temperature of the thermal chromatogram corresponding to the first resin in the third region from 1.0 μm to 1.1 μm in the depth direction from the outer surface of the conductive layer:

$$T 1 > T 3 \qquad ( 5 )$$

$$\vert T 1 - T 3 \vert > \vert T 3 - T 2 \vert \qquad ( 6 )$$

The formula (5) and formula (6) being satisfied can be confirmed by the microsampling mass spectrometry.

In order to allow the function of the conductive layer to be better exhibited, when the region with a depth of from 1.0 μm to 1.1 μm from the outer surface of the conductive layer, and a thickness of 0.1 μm is assumed to be a third region, in the third region adjacent to the first region, the IPN structure is preferably not present. Alternatively, even when the IPN structure is present, the IPN structure preferably has a weaker degree of penetration of the second resin as compared with the IPN structure in the first region.

Therefore, T1, T2, and T3 preferably satisfy the relationship expressed by the formula (5) and the relationship expressed by the formula (6), where T3 (° C.) represents the peak top temperature of the thermal chromatogram corresponding to the first resin, measured from the sample sampled from the third region.

The value of T3 can be adjusted by the crosslinking density of the first resin, and the like.

### Other Components

The conductive layer can be allowed to include, other than the foregoing ones, a conductive substance, a crosslinking agent, a plasticizer, a filler, an extender, a vulcanizing agent, a vulcanizing aid, a crosslinking aid, an antioxidant, an age register, a processing aid, a levelling agent, and the like within such a range as not to impair the function of the conductive layer. Further, when the conductive layer is required to have surface roughness, a fine particle for imparting the conductive layer with roughness can be included therein. Specifically, a fine particle of a polyurethane resin, a polyester resin, a polyether resin, a polyamide resin, a (meth)acrylic resin, a polycarbonate resin, or the like can be used. The volume average particle diameter of the fine particle is preferably from 1.0 μm to 30 μm, and the surface roughness (10-point average roughness) Rzjis formed by the fine particle is preferably from 0.1 μm to 20 μm. Incidentally, the Rzjis is the value measured on the basis of JIS B0601 (1994).

### Substrate

A conductive substrate 2 functions as the electrode and the support member of the electrophotographic member 1. The substrate 2 includes, for example, a conductive material including a meal or an alloy such as aluminum, a copper alloy, or stainless steel; iron subjected to a plating treatment with chromium or nickel; a synthetic resin having conductivity, or the like.

Incidentally, a primer may be applied to the surface of the substrate in order to improve the adhesion between the substrate and an elastic layer described later. As the primer, for example, a silane coupling type primer, a urethane type, an acrylic, a polyester type, a polyether type or an epoxy type thermosetting resin, or thermoplastic resin can be used. As a commercially available primer, mention may be made of the following.
“DY39-051”, “DY39-012”, and “DY39-115” (all are trade names, manufactured by Toray Dow Corning Co.);
“X-33-173”, “PRIMER-NO. 4”, “PRIMER-NO. 32”, and “PRIMER-NO. 35” (all are trade names, manufactured by Shin-Etsu Chemical Co., Ltd.);
“XP81-405”, “XP81-A6361”, “XP81-B7015”, “ME21”, “ME151”, “ME153”, and “XC9214” (all are trade names, manufactured by Momentive Performance Materials⋅Japan Consolidated Company).

To the primer, known alkoxy silane, titanic acid ester, or the like may be added in order to improve the adhesion. As alkoxy silane and a titanic acid ester, specifically, mention may be made of tetramethoxysilane, tetraethoxysilane, tetra-normal butoxysilane, tetraethoxy titanium, tetraisopropoxy titanium, tetra-normal butoxytitanium, and the like. These are preferably added in an amount of 0.1 to 20 parts by mass for every 100 parts by mass of the primer.

### Elastic Layer

The elastic layer 4 has a function of imparting the electrophotographic member 1 with the elasticity required for forming a nip with a prescribed width in the contact region between the electrophotographic member 1 and the photosensitive member when the electrophotographic member is in a roller shape, namely, an electrophotographic roller. The elastic layer 4 is preferably a molded body of a rubber material. As the rubber materials, various rubber materials conventionally used for a conductive rubber roller can be used. As the rubber to be used for the rubber material, specifically, mention may be made of ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluorocarbon rubber, silicone rubber, epichlorohydrin rubber, hydride of NBR, polysulfide rubber, urethane rubber, and the like. These may be used singly alone, or may be used in a mixture of two or more thereof. Out of these, particularly from the viewpoint of the stability with respect to the deformation of the setting performance or the like, silicone rubber is preferable. As silicone rubbers, mention may be made of polydimethyl siloxane, polymethyl trifluoropropyl siloxane, polymethyl vinyl siloxane, and polyphenyl vinyl siloxane, copolymers of the polysiloxanes, and the like.

To the elastic layer 4, various additives such as a conductivity imparting agent, a non-conductive filler, a crosslinking agent, and a catalyst may be appropriately added. As the conductivity imparting agent, a fine particle of carbon black; a conductive metal such as aluminum or copper; conductive metal oxide such as zinc oxide, tin oxide, or titanium oxide can be used. Out of these, carbon black is preferable because carbon black can provide favorable conductivity in a relatively lower addition amount.

As carbon blacks, specifically, conductive carbon blacks such as Ketjen black (trade name, manufactured by Lion Co., Ltd.), and acetylene black; carbon blacks for rubber such as SAF, ISAF, HAF, FEF, GPF, SRF, FT, and MT, other than these, carbon black for a color ink subjected to an oxidation treatment, and pyrolysis carbon black can be used. These may be used singly alone, or may be used in combination of two or more thereof. When carbon black is used as a conductivity imparting agent, carbon black is more preferably mixed in an amount of 10 to 80 parts by mass for every 100 parts by mass of the rubber in the rubber material.

Further, as the non-conductive filler, mention may be made of silica, a quartz powder, titanium oxide, zinc oxide, calcium carbide, or the like. As the crosslinking agents, mention may be made of di-t-butyl peroxide, 2,5-dimethyl-2,5-di(t-butyl peroxy) hexane, or dicumyl peroxide. As the catalyst, mention may be made of a platinum type catalyst, a rhodium type catalyst, and a palladium type catalyst, and the platinum type catalyst is in particular preferable.

The elastic layer 4 may be formed of a plurality of layers. Further, an intermediate layer 5 may be provided between the substrate 2 and the elastic layer 4, and between the elastic layer 4 and the surface layer 3. The thickness of the elastic layer 4 is preferably 0.25 to 8.00 mm, and more preferably 0.30 to 3.00 mm.

### Electrophotographic Apparatus

An electrophotographic member in accordance with the present disclosure can be preferably used as a developer bearing member or a developer regulating member of an electrophotographic apparatus. The electrophotographic member is applicable to any developing apparatus of a non-contact type developing apparatus, and a contact type developing apparatus, using a magnetic one component toner or a non-magnetic one component toner and a developing apparatus using a two component toner. Namely, the electrophotographic image forming apparatus of the present disclosure preferably includes the electrophotographic member of the present disclosure as a development member.

FIG. 2 is a schematic cross sectional view showing one example of an electrophotographic apparatus mounting the electrophotographic member in accordance with the present disclosure as the development roller of a contact type developing apparatus using a one component toner. As shown in FIG. 2, a developing apparatus 22 is detachably mounted in the electrophotographic apparatus. The developing apparatus 22 includes a toner container 20 for accommodating a toner 15 as one component toner, a development roller 16, a toner supply roller 19 for supplying a toner to the development roller 16, and a development blade 21 for regulating the thickness of the toner layer on the development roller 16. The development roller 16 is situated at an opening extending in the longitudinal direction in the toner container 20, and is set opposed to the photosensitive member 18. Further, a process cartridge 17 including a photosensitive member 18, a cleaning blade 26, a waste toner accommodating container 25, and a charging roller 24 is detachably mounted in the electrophotographic apparatus. Incidentally, the photosensitive member 18, the cleaning blade 26, the waste toner accommodating container 25, and the charging roller 24 may be disposed at the electrophotographic apparatus main body.

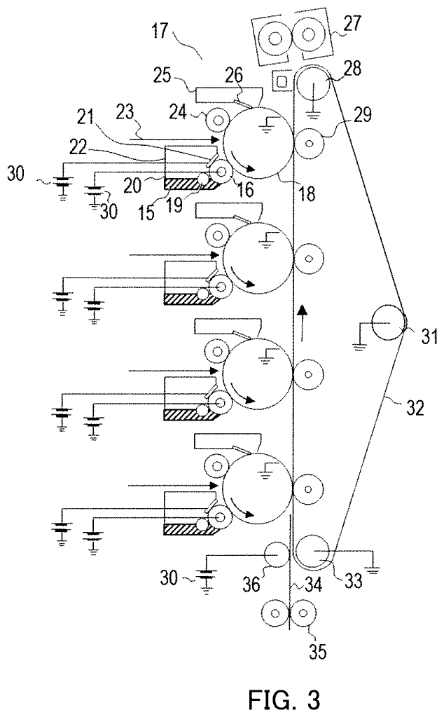

Below, the print operation of the electrophotographic apparatus will be described. FIG. 3 is a schematic cross sectional view of an example of an electrophotographic apparatus in accordance with one aspect of the present disclosure. The photosensitive member 18 rotates in the arrow direction, and is uniformly charged by a charging roller 24 for subjecting the photosensitive member 18 to a charging treatment. Then, a laser light 23 that is an exposure means forms an electrostatic latent image on the surface of the photosensitive member 18. The electrostatic latent image is visualized as a toner image (developed) by application of a toner 15 by the developing apparatus 22 arranged in contact with the photosensitive member 18. The development is so-called reversal development of forming a toner image at the exposed portion. The toner image formed on the photosensitive member 18 is transferred to a paper sheet 34 that is recording medium by a transfer roller 29 that is a transfer member. The paper sheet 34 is fed into the apparatus through a paper feed roller 35 and an adsorption roller 36, and is transported to between the photosensitive member 18 and the transfer roller 29 by an endless belt-shaped transfer transport belt 32. The transfer transport belt 32 is driven by a driven roller 33, a driver roller 28, and a tension roller 31. The transfer roller 29 and the adsorption roller 36 are applied with a voltage from the bias power supply 30. The paper sheet 34 onto which the toner image has been transferred is subjected to a fixing treatment by a fixing apparatus 27, and then, is discharged outside the apparatus, resulting in the completion of the print operation. On the other hand, the untransferred toner left on the photosensitive member 18 without being transferred is scraped off by a cleaning blade 26 that is a cleaning member for cleaning the photosensitive member surface, and is accommodated in a waste toner accommodating container 25. The cleaned photosensitive member 18 performs the print operation described up to this point repeatedly.

### Electrophotographic Process Cartridge

An electrophotographic member in accordance with the present disclosure can be preferably used as development members such as a developer bearing member, a developer supply⋅stripping member, and a developer regulating member in a process cartridge. Namely, the electrophotographic process cartridge of the present disclosure is an electrophotographic process cartridge configured detachably with respect to the main body of the electrophotographic apparatus, and may include the electrophotographic member of the present disclosure. Further, the electrophotographic member of the present disclosure is preferably included as a development member.

### Examples

Below, although the present disclosure will be described in details by way of specific Examples, the technical scope of the present disclosure is not limited thereto.

### Preparation of Raw Materials

### Synthesis of Polymerizable Monomers: Ion Compounds

First, ion compounds forming the structure expressed by the formula (1) (i.e., sulfonylimide type ion compounds having unsaturated reactive functional groups expressed by the formula (1′)) were synthesized. The synthesis examples of the ion compounds capable of forming the structure expressed by the formula (1) will be shown.

### Synthesis of Ion Compound C-1

Methacrylic acid 3-sulfopropyl potassium (manufactured by Tokyo Chemical Industry Co.) was suspended in an amount of 15.0 g (0.06 mol) in a mixture of 100 mL of tetrahydrofuran and 0.5 mL of N,N-dimethylformamide. Then, 20 mL (0.28 mol) of thionyl chloride was added thereto, and the mixture was stirred for 3 hours. This was subjected to vacuum concentration, and the residue was dissolved in dichloromethane, followed by washing by 50 mL of pure water and 50 mL of brine. Then, vacuum concentration was performed again, resulting in a pale-yellow liquid.

To a solution obtained by dissolving 9.20 g (0.06 mol) of trifluoromethane sulfonylimide (manufactured by Tokyo Chemical Industry Co.) and 27.3 mL (0.20 mol) of triethyl amine (manufactured by KISHIDA CHEMICAL Co., Ltd.) in 50 mL of tetrahydrofuran, the resulting pale yellow liquid was added, and stirring was performed for 2 hours. Subsequently, the reaction solution was subjected to vacuum concentration.

The resulting residue was dissolved in dichloromethane, followed by washing with 150 mL of pure water, and the organic layer was subjected to vacuum drying, resulting in a yellow liquid. The resulting yellow liquid was dissolved in 300 mL of tetrahydrofuran, and 1.43 g (0.18 mol) of lithium hydride (manufactured by FUJIFILM Wako Pure Chemical Industries, Ltd.) was added, and stirring was performed overnight. The unreacted lithium hydride was filtered out by cerite filtration, and then, the filtrate was subjected to vacuum drying, resulting in an ion compound C-1.

### Synthesis of Ion Compound C-2

An ion compound C-2 was obtained in the same manner as with the ion compound C-1, except for changing the starting material to 15.9 g (0.06 mol) of 3-Sulfopropyl Acrylate Potassium Salt (manufactured by Tokyo Chemical Industry Co.).

### Synthesis of Ion Compound C-3

Hydroxymethanesulfonate (manufactured by Atomax Chemicals Product Co.) was dissolved in an amount of 7.78 g (0.07 mol) in 50 mL of tetrahydrofuran, and 5.17 g (0.06 mol) of methacrylic acid (manufactured by KISHIDA CHEMICAL Co., Ltd.) and a molecular sieve were added thereto. Stirring was performed at 80° C. for 3 hours. The filtrate which has undergone cerite filtration was subjected to vacuum drying, and then was dissolved in 50 mL of THF again, and 2.41 g (0.06 mol) of potassium hydride (manufactured by MERCK Co.) was added thereto, and stirring was performed at room temperature for 2 hours. Using the white solid obtained after vacuum drying as the starting material, an ion compound C-3 was obtained in the same manner as with ion compound C-1.

### Synthesis of Ion Compound C-4

1-HEPTANESULFONYL CHLORIDE, 7-HYDROXY (manufactured by Hong Kong Chemhere Product Co.) in an amount of 12.9 g and 6.07 g (0.06 mol) of triethyl amine (manufactured by KISHIDA CHEMICAL Co., Ltd.) were added to 80 mL of dichloromethane, and stirred at room temperature. After washing with 100 mL of pure water, the organic phase was subjected to vacuum drying, resulting in an oily liquid. Sodium acylate (manufactured by MERCK Co.) was dissolved in an amount of 5.64 g (0.06 mol) in 50 mL of ethanol. The oily liquid previously obtained and 0.022 g (0.20 mmol) of hydroquinone (manufactured by KANTO CHEMICAL CO., INC.) were added thereto, and stirring was performed at 70° C. for 5 hours. Using the pale yellow solid obtained after vacuum drying as the starting material, an ion compound C-4 was obtained in the same manner as with the ion compound C-2.

### Synthesis of Ion Compound C-5

An ion compound C-5 was obtained in the same manner as with the ion compound C-2 except for changing Trifluoromethanesulfonamide (manufactured by Tokyo Chemical Industry Co.) to 5.94 g (0.06 mol) of sulfamoylfluoride (manufactured by Atomax Chemicals Product Co.) as the reactant.

### Synthesis of Ion Compound C-6

An ion compound C-6 was obtained in the same manner as with the ion compound C-1 except for changing Trifluoromethanesulfonamide (manufactured by Tokyo Chemical Industry Co.) to 18.0 g (0.06 mol) of nonafluorobutane-1-sulfonamide (manufactured by Enamine Co.) as the reactant.

### Synthesis of Ion Compound C-7

An ion compound C-7 was obtained in the same manner as with the ion compound C-5 except for changing lithium hydride to 4.32 g (0.18 mol) of Sodium Hydride (manufactured by Tokyo Chemical Industry Co.) as the reactant.

### Synthesis of Ion Compound C-8

An ion compound C-8 was obtained in the same manner as with the ion compound C-6 except for changing lithium hydride to 7.22 g (0.18 mol) of potassium hydride (manufactured by MERCK Co.) as the reactant.

The chemical structures of the resulting reactive ion compounds are expressed by the formulae C-1 to C-8.

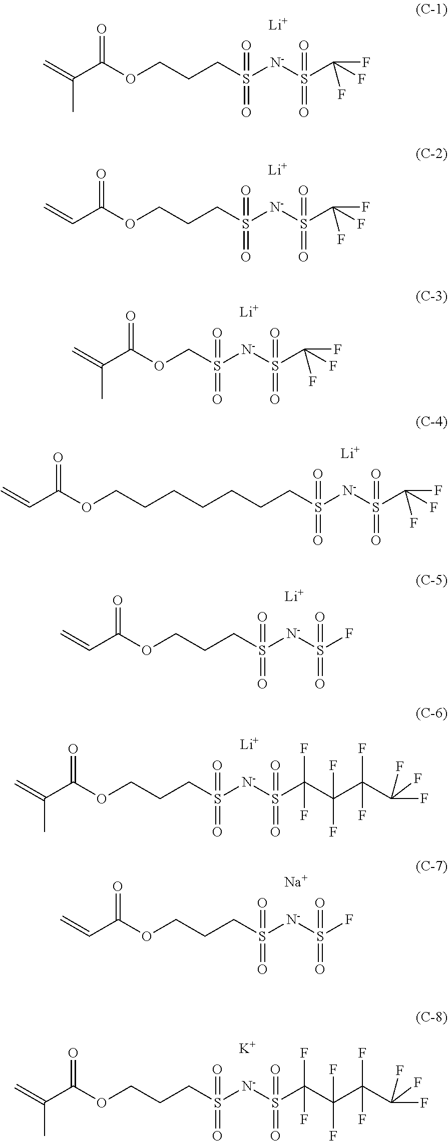

### Polymerizable Monomer

As the raw materials for an acrylic compound forming the structure expressed by the formula (2) (i.e., aliphatic (meth)acrylate expressed by the formula (2′)), those in Table 1 below were used.

TABLE 1

| (Meth)acryl | Formula (2) | Formula (2) | | |
|---|---|---|---|---|
| monomer | structure | structure | | |
| No. | R21 | R22 | Product name | Manufacturer |
| A-1 | CH3 | CH3 | Methyl Methacrylate | Manufactured by FUJIFILM Wako |
| | | | | Pure Chemical Industries, Ltd. |
| A-2 | CH3 | n-C4H9 | LIGHTESTER NB | Manufactured by KYOEISHA |
| | | | | CHEMICAL Co., LTD. |
| A-3 | CH3 | CH2CH(CH3)2 | LIGHTESTER IB | Manufactured by KYOEISHA |
| | | | | CHEMICAL Co., LTD. |
| A-4 | CH3 | n-C6H11 | n-Hexyl Methacrylate | Manufactured by FUJIFILM Wako |
| | | | | Pure Chemical Industries, Ltd. |
| A-5 | CH3 | Cy-C6H11 | LIGHTESTER CH | Manufactured by KYOEISHA |
| | | | | CHEMICAL Co., LTD. |
| A-6 | H | n-C4H9 | Butyl acrylate | Manufactured by TOAGOSEI CO., |
| | | | | LTD. |
| A-7 | H | CH2CH(CH3)2 | Isobutyl acrylate | Manufactured by TOAGOSEI CO., |
| | | | | LTD. |
| A-8 | H | Cy-C6H11 | ACRYX CHA | Manufactured by TOAGOSEI CO., |
| | | | | LTD. |

Synthesis of (Meth)acryl sulfonyl imide Conductive Agent (Second Resin) (Meth)acryl sulfonyl imide Conductive Agent IP-9

Into a 4-necked separable flask equipped with a stirrer, a cooler, a thermometer, and a nitrogen inlet tube, C-1 as a polymerizable monomer for providing the structural unit (1): 50.0 parts by mass, A-1 as a polymerizable monomer for providing the structural unit (2): 50.0 parts by mass, 1.0 L of dried ethanol, and 1.0 parts by mass of 2,2′-azobisisobutyronitrile (manufactured by Tokyo Chemical Industry Co.) were charged, and stirring was performed until the system became uniform. With stirring, the temperature was increased until the temperature in the reaction system became 70° C., and the reaction was effected with nitrogen introduced and refluxed for 8 hours. Thereafter, ethanol was distilled off, resulting in a (meth)acryl sulfonyl imide conductive agent IP-9, i.e., a copolymer.

(Meth)acryl sulfonyl imide Conductive Agents IP-10 to IP-24

(Meth)acryl sulfonyl imide conductive agents IP-10 to IP-24 were obtained in the same manner as with the synthesis of the IP-9, except for changing the kind and the addition amount of the polymerizable monomer to the conditions shown in Table 2 below.

TABLE 2

| Acryl | | | | |
|---|---|---|---|---|
| sulfonyl | | | | |
| imide | Reactive | | Acrylic | |
| conductive | ion | | monomer | |
| agent | | Parts by | | Parts by |
| No. | No. | mass | No. | mass |
| IP-9 | C-1 | 50 | A-1 | 50 |
| IP-10 | C-1 | 50 | A-2 | 50 |
| IP-11 | C-1 | 50 | A-3 | 50 |
| IP-12 | C-1 | 50 | A-4 | 50 |
| IP-13 | C-1 | 50 | A-5 | 50 |
| IP-14 | C-1 | 50 | A-6 | 50 |
| IP-15 | C-1 | 50 | A-7 | 50 |
| IP-16 | C-1 | 50 | A-8 | 50 |
| IP-17 | C-3 | 50 | A-2 | 50 |
| IP-18 | C-3 | 50 | A-6 | 50 |
| IP-19 | C-2 | 50 | A-2 | 50 |
| IP-20 | C-4 | 50 | A-2 | 50 |
| IP-21 | C-5 | 50 | A-2 | 50 |
| IP-22 | C-6 | 50 | A-2 | 50 |
| IP-23 | C-7 | 50 | A-2 | 50 |
| IP-24 | C-8 | 50 | A-2 | 50 |

### Synthesis of Isocyanate Group Terminal Prepolymer

An isocyanate compound for forming a urethane resin was synthesized.

### Synthesis of Isocyanate Group Terminal Prepolymer B-1

Under a nitrogen atmosphere, in a reaction container, 100.0 parts by mass of polypropylene glycol type polyol (trade name: Exenol 230; manufactured by AGC Co., Ltd.) was gradually added dropwise for every 33.8 parts by mass of polymeric MDI (trade name: MILLIONATE MR; manufactured by Tosoh Corporation) while keeping the temperature in the reaction container at 65° C.

After completion of the dropwise addition, the reaction was effected at a temperature of 65° C. for 2 hours, and 57.3 parts by mass of methyl ethyl ketone was added thereto. The resulting reaction mixture was cooled to room temperature, resulting in an isocyanate group terminal urethane prepolymer B-1 with an isocyanate group content of 4.80 wt %.

### Synthesis of Isocyanate Group Terminal Prepolymer B-2

Under a nitrogen atmosphere, in the reaction container, 8.8 parts by mass of polymeric MDI (trade name: MILLIONATE MT; manufactured by Tosoh Corporation) was dissolved in methyl ethyl ketone so that the final solid content became 50 mass %. Subsequently, 100.0 parts by mass of olefin type polyol (trade name: Poly bd R-45HT; manufactured by Idemitsu Kosan Co., Ltd.) was gradually added dropwise into the reaction container while keeping the temperature in the reaction container at 65° C.

After completion of the dropwise addition, the reaction was effected at a temperature of 65° C. for 2 hours. The resulting reaction mixture was cooled to room temperature, resulting in an isocyanate group terminal prepolymer B-2 with a solid content of 50 mass %, and an isocyanate group content of 1.40 wt %.

### Synthesis of Isocyanate Group Terminal Prepolymer B-3

Under a nitrogen atmosphere, in the reaction container, 100.0 parts by mass of HDI (trade name, manufactured by Tosoh Corporation) was dissolved in methyl ethyl ketone so that the final solid content became 50 mass %. Subsequently, while keeping the temperature in the reaction container at 65° C., 100.0 parts by mass of polypropylene glycol type polyol (trade name: Exenol 230; manufactured by AGC Co., Ltd.) was gradually added dropwise in the reaction container.

After completion of the dropwise addition, the reaction was effected at a temperature of 65° C. for 2 hours. The resulting reaction mixture was cooled to room temperature, resulting in an isocyanate group terminal prepolymer B-3 with a solid content of 50 mass %, and an isocyanate group content of 3.20 wt %.

### Synthesis of Isocyanate Group Terminal Prepolymer B-4

Under a nitrogen atmosphere, in the reaction container, 100.0 parts by mass of HDI (trade name, manufactured by Tosoh Corporation) was dissolved in methyl ethyl ketone so that the final solid content became 50 mass %. Subsequently, while keeping the temperature in the reaction container at 65° C., 100.0 parts by mass of olefin type polyol (trade name: Poly bd R-45HT; manufactured by Idemitsu Kosan Co., Ltd.) was gradually added dropwise in the reaction container.

After completion of the dropwise addition, the reaction was effected at a temperature of 65° C. for 2 hours. The resulting reaction mixture was cooled to room temperature, resulting in an isocyanate group terminal prepolymer B-4 with a solid content of 50 mass %, and an isocyanate group content of 1.22 wt %.

The raw materials and the physical properties of the isocyanate group terminal prepolymers B-1 to B-4 are shown in Table 3.

TABLE 3

| | Isocyanate compound | | | Chain extender material | | | Effective |
|---|---|---|---|---|---|---|---|
| No. | Compound | Product name | Manufacturer | Compound | Product name | Manufacturer | NCO % |
| B-1 | POLYMERIC | MILLIONATE | Tosoh | Polypropylene | EXENOL 230 | AGC | 4.80 |
| | MDI | MR | Corporation | glycol type polyol | | | |
| B-2 | POLYMERIC | MILLIONATE | Tosoh | Olefin type polyol | Poly bd R-45HT | Idemitsu Kosan | 1.40 |
| | MDI | MR | Corporation | | | Co., Ltd. | |
| B-3 | HDI | HDI | Tosoh | Polypropylene | EXENOL 230 | AGC | 3.20 |
| | | | Corporation | glycol type polyol | | | |
| B-4 | HDI | HDI | Tosoh | Olefin type polyol | iPoly bd R-45HT | Idemitsu Kosan | 1.22 |
| | | | Corporation | | | Co., Ltd. | |

### Manufacturing of Conductive Layer Forming Paint

### Preparation of Conductive Layer Forming Paint E-9

As the materials of the conductive layer, the materials shown in Table 4 below were mixed with stirring.

Then, methyl ethyl ketone was added thereto so that the total solid content became 30 mass %, followed by mixing by a sand mill. Then, further, the viscosity was adjusted to 10 to 13 cps by methyl ethyl ketone, thereby preparing a conductive layer forming paint E-9.

TABLE 4

| | Parts by |
|---|---|
| Material | mass |
| Polypropylene glycol type polyol (trade name: | 59.2 |
| EXENOL 230; manufactured by AGC Co.) | |
| Isocyanate terminal prepolymer B-1 | 58.4 |
| (Meth)acryl sulfonyl amide conductive agent IP-9 | 2.0 |
| Silica (trade name: AEROSIL 200; manufactured by | 15.0 |
| JAPAN AEROSIL CO.) | |
| Urethane resin particle (trade name: ART PERAL C-400; | 10.0 |
| manufactured by Negami Chemical Industrial Co., Ltd.) | |

### Preparation of Conductive Layer Forming Paint E′-1

As the materials of the conductive layer, the materials shown in Table 5 below were mixed with stirring, and a conductive layer forming paint E′-1 was obtained in the same manner as with the E-1.

TABLE 5

| | Parts by |
|---|---|
| Material | mass |
| Polypropylene glycol type polyol (trade name: | 59.2 |
| EXENOL 230; manufactured by AGC Co.) | |
| Isocyanate terminal prepolymer B-1 | 58.4 |
| Silica (trade name: AEROSIL 200; manufactured by | 17.0 |
| JAPAN AEROSIL CO.) | |
| Urethane resin particle (trade name: ART PERAL C-400; | 10.0 |
| manufactured by Negami Chemical Industrial Co., Ltd.) | |

Preparation of Conductive Layer Forming Paints E′-2 to E′-4 Conductive layer forming paints E′-2 to E′-4 were obtained in the same manner as with E-1, except for mixing the materials shown in Table 6 below with stirring as the materials for the conductive layer forming paints.

TABLE 6

| Conductive | Conductive layer forming resin | | | | | | | |
|---|---|---|---|---|---|---|---|---|
| layer | Polyol | | Curing agent | | Silica | | Urethan resin particle | |
| forming | | Parts by | | Parts by | | Parts by | Product | Parts by |
| paint No. | No. | mass | No. | mass | Product name | mass | name | mass |
| E′-1 | EXENOL 230 | 59.2 | B-1 | 58.4 | AEROSIL200 | 17.0 | ART PEARL | 10.0 |
| E′-2 | Poly bd R-45HT | 17.9 | B-2 | 82.1 | | | C-400 | |
| E′-3 | EXENOL 230 | 25.4 | B-3 | 74.6 | | | | |
| E′-4 | Poly bd R-45HT | 16.8 | B-4 | 83.2 | | | | |

### Preparation of Conductive Layer Forming Paint

The conductive layer forming paints of Table 7 below were obtained by the same procedure as with the conductive layer forming paint E-9 except for changing the kinds of polyol and the curing agent, and the addition amounts thereof, and the kind of the (meth)acryl sulfonyl imide conductive agent as in Table 7 below.

TABLE 7

| | | | | | (Meth)acryl sulfonyl amide | | |
|---|---|---|---|---|---|---|---|
| | | | | | conductive agent | | |
| Conductive | Conductive layer forming resin | | | | | | (Meth) |
| layer | Polyol | | Curing agent | | | Ion | acrylic |
| forming | | Parts by | | Parts by | | component | monomer |
| paint No. | No. | mass | No. | mass | No. | No. | No. |
| E-9 | EXENOL 230 | 59.2 | B-1 | 58.4 | IP-9 | C-1 | A-1 |
| E-10 | | | | | IP-10 | C-1 | A-2 |
| E-11 | | | | | IP-11 | C-1 | A-3 |
| E-12 | | | | | IP-12 | C-1 | A-4 |
| E-13 | | | | | IP-13 | C-1 | A-5 |
| E-14 | | | | | IP-14 | C-1 | A-6 |
| E-15 | | | | | IP-15 | C-1 | A-7 |
| E-16 | | | | | IP-16 | C-1 | A-8 |
| E-17 | | | | | IP-17 | C-3 | A-2 |
| E-18 | | | | | IP-18 | C-3 | A-6 |
| E-19 | | | | | IP-19 | C-2 | A-2 |
| E-20 | | | | | IP-20 | C-4 | A-2 |
| E-21 | | | | | IP-21 | C-5 | A-2 |
| E-22 | | | | | IP-22 | C-6 | A-2 |
| E-23 | | | | | IP-23 | C-7 | A-2 |
| E-24 | | | | | IP-24 | C-8 | A-2 |
| E-27 | Poly bd R-45HT | 18.0 | B-2 | 72.0 | IP-10 | C-1 | A-2 |
| E-28 | | | | | IP-19 | C-2 | A-2 |
| E-31 | EXENOL 230 | 27.0 | B-3 | 63.0 | IP-10 | C-1 | A-2 |
| E-32 | | | | | IP-19 | C-2 | A-2 |
| E-35 | Poly bd R-45HT | 30.0 | B-4 | 70.0 | IP-10 | C-1 | A-2 |
| E-36 | | | | | IP-19 | C-2 | A-2 |
| EH-1 | EXENOL 230 | 59.2 | B-1 | 58.4 | — | Li•TSFI | — |
| EH-2 | | | | | IPH-1 | Li•TSFI | — |
| EH-3 | | | | | IPH-1 | — | — |

### Manufacturing of Impregnation Treatment Solution

As the materials of the impregnation treatment solution for an impregnation treatment, the materials shown in Table 8 below were mixed with stirring.

TABLE 8

| | Ion conductive | | (Meth)acrylic | | Ion | | | | | |
|---|---|---|---|---|---|---|---|---|---|---|
| Impregnation | monomer | | monomer | | component | | Initiator | | Solvent | |
| treatment | | Number | | Number | | Number | | Number | | Number |
| solution No. | No. | of parts | No. | of parts | No. | of parts | Name | of parts | Name | of parts |
| G-2 | C-1 | 3 | A-2 | 3 | — | — | IRGACURE 184 | 0.2 | MEK | 100 |
| G-4 | C-3 | 3 | A-2 | 3 | — | — | (tradename, | | | |
| G-6 | C-5 | 3 | A-2 | 3 | — | — | manufactured by | | | |
| G-8 | C-7 | 3 | A-2 | 3 | — | — | BASF JAPAN Co.) | | | |
| GH-1 | — | — | A-2 | 5.9 | Li•TFSI | 0.1 | | | | |

In the table, Li⋅TFSI represents (lithium bis(trifluoromethane sulfonyl)imide) (the same also applies to the following). Further, MEK represents methyl ethyl ketone.

### Manufacturing of Conductive Roller

### Manufacturing of Silicone Rubber Elastic Roller D′-1

As the conductive substrate, the one obtained by applying a core metal with an outer diameter of 6 mm, and a length of 264 mm, and made of SUS304 with a primer (trade name: DY35-051, manufactured by Toray Dow Corning Co., Ltd.), followed by heating at a temperature of 150° C. for 20 minutes was prepared. The conductive substrate was set so as to be concentric in a cylindrical mold with an inside diameter of 11.5 mm.

As the material for the elastic layer, an addition type silicone rubber composition obtained by mixing the materials shown in Table 9 below by a trimix (trade name: manufactured by TX-15 manufactured by INOUE MFG., INC.) was injected into the mold heated to a temperature of 115° C. After injecting the material, heating and molding were performed at a temperature of 120° C. for 10 minutes, and the temperature was cooled to room temperature, followed by demolding from the mold, resulting in an elastic roller D′-1 including an intermediate layer with a thickness of 2.71 mm formed at the outer circumference of the conductive base material.

TABLE 9

| | Parts by |
|---|---|
| Material | mass |
| Liquid dimethyl polysiloxane having two or more silicon atom-bonded alkenyl groups | 100.0 |
| per molecule (trade name: SF 3000E, a viscosity of 10000 cP, and a vinyl group | |
| equivalent of 0.05 mmol/g, manufactured by KCC Co.) | |
| Platinum type catalyst (trade name: SIP 6832.2, manufactured by Gelest Co.) | 0.048 |
| Dimethyl polysiloxane having two or more silicon atom-bonded hydrogen atoms per | 0.5 |
| molecule (trade name: SP 6000P, a Si-H group equivalent of 15.5 mmol/g, | |
| manufactured by KCC Co.) | |
| Carbon black (trade name: TOKA BLACK #7360SB, manufactured by Tokai Carbon | 6.0 |
| Co., Ltd.) | |

### Manufacturing of NBR Rubber Elastic Roller D′-2

Respective materials of the kinds and the amounts shown in Table 10 below were mixed by a pressure kneader, resulting in an A-kneaded rubber composition.

TABLE 10

| | Parts by |
|---|---|
| Material | mass |
| NBR rubber (trade name; Nipol DN219; manufactured by Zeon Corporation) | 100.0 |
| Carbon black (product name: TOKA BLACK #4300; manufactured by | 40.0 |
| TOKAI Carbon Co., Ltd.) | |
| Calcium carbide (trade name: NANOX #30; manufactured by MARUO | 20.0 |
| CALCIUM CO., LTD.) | |
| Stearic acid (trade name; Stearic acid S; manufactured by KAO Corp.) | 1.0 |

Further, 166.0 parts by mass of the A-kneaded rubber composition and respective materials of the kinds and the amounts shown in Table 11 below were mixed by an open roll, thereby preparing an unvulcanized rubber composition.

TABLE 11

| | Parts by |
|---|---|
| Material | mass |
| Sulfur (trade name: Sulfax 200S; manufactured by | 1.2 |
| Tsurumi Chemical Industry Co., Ltd.) | |
| Tetrabenzyl thiuram disulfide (product name: | 4.5 |
| TBZTD; manufactured by SANSHIN CHEMICAL | |
| INDUSTRY CO., LTD.) | |

Then, a crosshead extruder having a supply mechanism of a conductive axial core body, and a discharge mechanism of an unvulcanized rubber roller was prepared. A die with an inside diameter of 16.5 mm was attached to the crosshead, and the crosshead extruder was adjusted to 80° C., and the transport speed of the conductive axial core body was adjusted to 60 mm/sec. Under the conditions, an unvulcanized rubber composition was supplied by the extruder, and the unvulcanized rubber composition was coated as an unvulcanized rubber layer on the circumferential surface of the conductive axial core body prepared above in the crosshead, resulting in an unvulcanized rubber roller. Then, the unvulcanized rubber roller was charged into a 170° C. hot air current vulcanizing furnace, and was heated for 60 minutes, resulting in an unpolished conductive roller. Thereafter, the tip of the NBR rubber elastic layer obtained by vulcanizing the unvulcanized rubber layer was cut and removed, and the surface of the NBR rubber elastic layer was polished by a grindstone. As a result of this, an elastic roller D′-2 with each diameter at positions 90 mm toward opposite ends from the central portion of 8.4 mm, and with a diameter at the central portion of 8.5 mm was manufactured.

### Example 1-2

First, the elastic roller D′-1 manufactured previously was immersed in the conductive layer forming paint E′-1, thereby forming a coating film of the pain on the surface of the elastic layer, followed by air drying. Further, at a temperature of 150° C., a heat treatment was performed for 1 hour, thereby providing a conductive layer with a film thickness of about 15 μm at the elastic layer outer circumference. As a result, a precursor (electrophotographic member precursor) of a conductive roller DG-1 was manufactured.

Subsequently, a treatment of immersing the precursor in an immersion treatment solution G-2 for 2 seconds was performed, and a (meth)acrylic component as with an ion conductive monomer was immersed therein. Thereafter, at normal temperatures, air drying was performed for 30 minutes, and drying was performed at 90° C. for 1 hour, thereby volatilizing the solvent. While rotating the elastic roller after drying, an ultraviolet ray was applied so that the cumulative light amount became 15000 mJ/cm², thereby curing the (meth)acrylic component. Incidentally, as an ultraviolet irradiation device, a high pressure mercury lamp (trade name: handy type UV curing device, manufactured by Marionetwork Co.) was used. As a result of this, a development roller DG-2 for use in Example was obtained.

### Other Examples and Comparative Examples

In the same manner as in Example 1-2 except for changing the conductive layer forming paint to be used to those shown in Table 12, a coating film was formed on the surface of the elastic layer of the elastic roller D′-1 or D′-2, and was dried, followed by a heat treatment at a temperature of 150° C. for 1 hour, resulting in the conductive rollers DG-2, DG-4, DG-6, and DG-8 to DG-21 in accordance with Examples 1-4, 1-6, and 1-8 to 1-21 of Table 12 below, and a conductive roller DHG-1 in accordance with Comparative Example 1-1.

TABLE 12

| | | | | | (Meth)acryl sulfonyl amide | | | Impregnation treatment solution | | |
|---|---|---|---|---|---|---|---|---|---|---|
| | | | | Conductive | | | (meth) | | | (meth) |
| | | | Elastic | layer | Conductive | Ion | acrylic | Treatment | Ion | acrylic |
| | | Conductive | roller | forming | agent | component | monomer | solution | component | monomer |
| Ex. | C.E. | roller No. | No. | paint No. | No. | No. | No. | No. | No. | No. |
| 1-2 | — | DG-2 | D′-1 | E′-1 | — | — | — | G-2 | C-1 | A-2 |
| 1-4 | — | DG-4 | D′-1 | E′-1 | — | — | — | G-4 | C-3 | A-2 |
| 1-6 | — | DG-6 | D′-1 | E′-1 | — | — | — | G-6 | C-5 | A-2 |
| 1-8 | — | DG-8 | D′-1 | E′-1 | — | — | — | G-8 | C-7 | A-2 |
| 1-9 | — | DG-9 | D′-1 | E′-2 | — | — | — | G-2 | C-1 | A-2 |
| 1-10 | — | DG-10 | D′-1 | E′-2 | — | — | — | G-4 | C-3 | A-2 |
| 1-11 | — | DG-11 | D′-1 | E′-2 | — | — | — | G-6 | C-5 | A-2 |
| 1-12 | — | DG-12 | D′-1 | E′-2 | — | — | — | G-8 | C-7 | A-2 |
| 1-13 | — | DG-13 | D′-1 | E′-3 | — | — | — | G-2 | C-1 | A-2 |
| 1-14 | — | DG-14 | D′-1 | E′-3 | — | — | — | G-4 | C-3 | A-2 |
| 1-15 | — | DG-15 | D′-1 | E′-3 | — | — | — | G-6 | C-5 | A-2 |
| 1-16 | — | DG-16 | D′-1 | E′-3 | — | — | — | G-8 | C-7 | A-2 |
| 1-17 | — | DG-17 | D′-1 | E′-4 | — | — | — | G-2 | C-1 | A-2 |
| 1-18 | — | DG-18 | D′-1 | E′-4 | — | — | — | G.4 | C3 | A-2 |
| 1-19 | — | DG-19 | D′-1 | E′-4 | — | — | — | G-6 | C-5 | A-2 |
| 1-20 | — | DG-20 | D′-1 | E′-4 | — | — | — | G-8 | C-7 | A-2 |
| 1-21 | — | DG-21 | D′-2 | E′-1 | — | — | — | G-2 | C-1 | A-2 |
| 2-9 | — | D-9 | D′-1 | E-9 | IP-9 | C-1 | A-1 | — | — | — |
| 2-10 | — | D-10 | D′-1 | E-10 | IP-10 | C-1 | A-2 | — | — | — |
| 2-11 | — | D-11 | D′-1 | E-11 | IP-11 | C-1 | A-3 | — | — | — |
| 2-12 | — | D-12 | D′-1 | E-12 | IP-12 | C-1 | A-4 | — | — | — |
| 2-13 | — | D-13 | D′-1 | E-13 | IP-13 | C-1 | A-5 | — | — | — |
| 2-14 | — | D-14 | D′-1 | E-14 | IP-14 | C-1 | A-6 | — | — | — |
| 2-15 | — | D-15 | D′-1 | E-15 | IP-15 | C-1 | A-7 | — | — | — |
| 2-16 | — | D-16 | D′-1 | E-16 | IP-16 | C-1 | A-8 | — | — | — |
| 2-17 | — | D-17 | D′-1 | E-17 | IP-17 | C-3 | A-2 | — | — | — |
| 2-18 | — | D-18 | D′-1 | E-18 | IP-18 | C-3 | A-6 | — | — | — |
| 2-19 | — | D-19 | D′-1 | E-19 | IP-19 | C-2 | A-2 | — | — | — |
| 2-20 | — | D-20 | D′-1 | E-20 | IP-20 | C-4 | A-2 | — | — | — |
| 2-21 | — | D-21 | D′-1 | E-21 | IP-21 | C-5 | A-2 | — | — | — |
| 2-22 | — | D-22 | D′-1 | E-22 | IP-22 | C-6 | A-2 | — | — | — |
| 2-23 | — | D-23 | D′-1 | E-23 | IP-23 | C-7 | A-2 | — | — | — |
| 2-24 | — | D-24 | D′-1 | E-24 | IP-24 | C-8 | A-2 | — | — | — |
| 2-27 | — | D-27 | D′-1 | E-27 | IP-10 | C-1 | A-2 | — | — | — |
| 2-28 | — | D-28 | D′-1 | E-28 | IP-19 | C-2 | A-2 | — | — | — |
| 2-31 | — | D-31 | D′-1 | E-31 | IP-10 | C-1 | A-2 | — | — | — |
| 2-32 | — | D-32 | D′-1 | E-32 | IP-19 | C-2 | A-2 | — | — | — |
| 2-35 | — | D-35 | D′-1 | E-35 | IP-10 | C-1 | A-2 | — | — | — |
| 2-36 | — | D-36 | D′-1 | E-36 | IP-19 | C-2 | A-2 | — | — | — |
| — | 1-1 | DGH-1 | D′-1 | E′-1 | — | — | — | GH-1 | Li•TSFI | A-2 |
| — | 2-1 | DH-1 | D′-1 | EH-1 | — | Li•TSFI | — | — | — | — |
| — | 2-2 | DH-2 | D′-1 | EH-2 | IPH-1 | Li•TSFI | — | — | — | — |
| — | 2-3 | DH-3 | D′-1 | EH-3 | IPH-1 | — | — | — | — | — |
| — | 2-5 | DH-5 | D′-2 | EH-2 | IPH-1 | Li•TSFI | — | — | — | — |

In the table. Ex. represents Example and C. E. represents Comparative Example.

### Examples 2-9

The elastic roller D′-1 manufactured previously was immersed in the conductive layer forming paint (E-9) shown in Table 7, thereby forming a coating film the paint on the surface of the elastic layer, followed by air drying. Further, at a temperature of 150° C., a heat treatment was performed for 1 hour, thereby providing a conductive layer with a film thickness of about 15 μm at the elastic layer outer circumference. As a result, a conductive roller D-9 for use in Examples 2-9 was manufactured.

### Other Examples and Comparative Examples

In the same manner as with Example 2-9 except for changing the conductive layer forming paint to be used to that shown in the table, a coating film was formed on the surface of the elastic layer of the elastic roller D′-1, and was dried, followed by a heat treatment at temperature of 150° C. for 1 hour. This resulted in conductive rollers D-9 to D-24, D-27, D-28, D-31, D-32, D-35, and D-36 in accordance with Examples 2-9 to 2-24, 2-27, 2-28, 2-31, 2-32, 2-35, and 2-36, and conductive rollers DH-1 to DH-3, and DH-5 in accordance with Comparative Examples 2-1 to 2-3, and 2-5 shown in Table 12.

### Structure Confirmation of Manufactured Product

The resin obtained in the present synthesis example was subjected to analysis with a pyrolysis device (trade name: Pyrofoil Sampler JPS-700, manufactured by Japan Analytical Industry Co., Ltd.) and a GC/MS device (trade name: Focus GC/ISQ, manufactured by Thermo Fisher Scientific Co.), using helium as a carrier gas at a pyrolysis temperature of 590° C. As a result, it was confirmed from the resulting fragment peak that the structure expressed by the formula (1) and the structure expressed by the formula (2) were included.

### Measurement of T1, T2, T3, A1, and A2

The microsampling mass spectrometry resulted in the thermal chromatograms of a first region to a depth of 0.1 μm from the outer surface (the surface opposite to the side opposed to the substrate) of the conductive layer, a second region with a thickness of 0.1 μm toward the outer surface from the inner surface (the surface opposite to the substrate) of the conductive layer, and a third region of from 1.0 μm to 1.1 μm in the depth direction from the outer surface. From the resulting thermal chromatograms, T1 (° C.), T2 (° C.), and T3 (° C.) were determined as the peak top temperatures of the thermal chromatograms corresponding to polyurethanes in respective regions of the first region, the second region, and the third region. Further, the peak top temperature A1 of the thermal chromatogram corresponding to the second resin in the first region was obtained. Still further, the polyurethane included in the sample sampled from the first region was decomposed by the pyridine decomposition method described later, resulting in a second sample. Then, a peak top temperature A2 of the thermal chromatogram corresponding to the second resin, measured from the second sample was obtained.

Incidentally, the sample of each region was collected using the microsampling method by a FIB-SEM (trade name: NVision 40, manufactured by SII Nanotechnology Co.).

Specifically, first, a cut was made toward the substrate from the outer surface of the conductive layer using a razor, and a rubber piece with the cross sections of the conductive layer and the intermediate layer exposed was cut out. The rubber piece was set on a sample stand for SEM so that the cross sectional portion of the conductive layer became the upper surface, and a sampling probe was fixed at the position corresponding to the outer surface of the conductive layer of the rubber piece. Further, at the position equivalent to 0.1 μm inward of the surface corresponding to the outer surface of the conductive layer, a cutting treatment by FIB was performed, thereby collecting a sample of the first region.

As for the second region, at a position 1.0 μm toward the outer surface side from the interface between the inner surface and the intermediate layer of the conductive layer, a cutting treatment by FIB was performed. To the resulting cut surface, a sampling probe was fixed, and at the position corresponding to 0.1 μm inward of the cut surface, a cutting treatment by FIB was performed, thereby collecting a sample in the second region.

Further, for the third region, with the same rubber piece as described above, at the position corresponding to 1.0 μm inward of the surface corresponding to the outer surface of the conductive layer, a cutting treatment by FIB is performed, thereby exposing the third region. To the exposed surface, a sampling probe was fixed. At the position corresponding to 0.1 μm inward of the exposed surface, a cutting treatment by FIB was performed, thereby collecting a sample of the third region.

In any cutting treatment, the acceleration voltage of FIB was set at 30 kV, and the beam current was set at 27 mA.

### Pyridine Decomposition Method

The pyridine decomposition method is the method for selectively decomposing a urethane bond. Namely, when the first resin is polyurethane, whether the IPN structure is present or not can be confirmed by the pyridine decomposition method. For the sample having the IPN structure of the second resin and polyurethane, the pyridine decomposition method is performed. As a result, the second resin after removing the structure derived from polyurethane can be obtained. From the resulting second resin, the change in peak temperature of the thermal chromatogram due to the presence or absence of the IPN structure can be grasped. The pyridine decomposition method is performed specifically in the following manner.

Using a microtome, a sample was cut out with a thickness of 0.1 μm from the outer surface of the conductive layer, and was collected in an amount of 500 mg. To the resulting sample, 0.5 mL of a mixed solution obtained by mixing pyridine (manufactured by Wako Pure Chemical Industries, Ltd.) and water at a mass ratio of 3:1 was added. The mixture was heated at 130° C. for 15 hours in an enclosed container made of a fluorine resin (Teflon (registered trademark)) with a stainless steel jacket, thereby performing decomposition. The resulting decomposed product was subjected to a depressurization treatment, thereby removing pyridine. Using the sample thus obtained, the microsampling mass spectrometry was performed, resulting in the value of A2. From the obtained values of A1 and A2 and the formula (X), whether the IPN structure was present or not was determined. The results are shown in Table 13.

When the first resin is not polyurethane, whether the IPN structure is present or not can be identified in the following manner. Namely, only the raw materials of the second resin are cured, thereby obtaining the second resin. With the resulting second resin as the measurement sample, the microsampling mass spectrometry is performed. The peak top temperature of the resulting thermal chromatogram is the peak top temperature when the second resin is present as a simple substance. For this reason, the peak top temperature corresponds to the peak top temperature A2 of the thermal chromatogram.

### Evaluation of Conductive Roller

The resulting conductive rollers in accordance with Examples and Comparative Examples were evaluated regarding the following items. The results are shown in Table 13 below.

TABLE 13

| | | | | | | | | Roller | | |
|---|---|---|---|---|---|---|---|---|---|---|
| | | | | | | | Initial | resistance | | |
| | | | | | | | roller | after | | |
| | | | Formula | Formula | Formula | Formula | resistance | electrification | Electrification | |
| Ex. | C.E. | IPN | (3) | (4) | (5) | (6) | (Ω) | (Ω) | deterioration | Ghost |
| 1-2 | — | Present | Y | Y | Y | Y | 2.01E+05 | 2.05E+05 | 1.02 | A |
| 1-4 | — | Present | Y | Y | Y | Y | 2.03E+05 | 2.08E+05 | 1.02 | A |
| 1-6 | — | Present | Y | Y | Y | Y | 2.06E+05 | 2.10E+05 | 1.02 | A |
| 1-8 | — | Present | Y | Y | Y | Y | 2.11E+05 | 2.16E+05 | 1.02 | A |
| 1-9 | — | Present | Y | Y | Y | N | 3.20E+05 | 3.31E+05 | 1.03 | A |
| 1-10 | — | Present | Y | Y | Y | N | 3.32E+05 | 3.41E+05 | 1.03 | A |
| 1-11 | — | Present | Y | Y | Y | N | 3.42E+05 | 3.51E+05 | 1.03 | A |
| 1-12 | — | Present | Y | Y | Y | N | 3.55E+05 | 3.64E+05 | 1.03 | A |
| 1-13 | — | Present | Y | Y | N | N | 3.61E+05 | 3.72E+05 | 1.03 | A |
| 1-14 | — | Present | Y | Y | N | N | 3.72E+05 | 3.85E+05 | 1.03 | A |
| 1-15 | — | Present | Y | Y | N | N | 3.75E+05 | 3.88E+05 | 1.03 | A |
| 1-16 | — | Present | Y | Y | N | N | 3.80€+05 | 3.93E+05 | 1.03 | A |
| 1-17 | — | Present | Y | N | N | N | 4.02E+05 | 4.20E+05 | 1.04 | A |
| 1-18 | — | Present | Y | N | N | N | 4.11E+05 | 4.27E+05 | 1.04 | A |
| 1-19 | — | Present | Y | N | N | N | 4.23E+05 | 4.39E+05 | 1.04 | A |
| 1-20 | — | Present | Y | N | N | N | 4.32E+05 | 4.48E+05 | 1.04 | A |
| 1-21 | — | Present | Y | N | N | N | 4.75E+05 | 5.80E+05 | 1.22 | A |
| 2-9 | — | Absent | N | N | N | N | 3.52E+06 | 3.91E+06 | 1.11 | A |
| 2-10 | — | Absent | N | N | N | N | 3.93E+06 | 4.83E+06 | 1.23 | A |
| 2-11 | — | Absent | N | N | N | N | 3.54E+06 | 4.04E+06 | 1.14 | A |
| 2-12 | — | Absent | N | N | N | N | 3.01E+06 | 3.55E+06 | 1.18 | A |
| 2-13 | — | Absent | N | N | N | N | 4.79E+06 | 5.56E+06 | 1.16 | A |
| 2-14 | — | Absent | N | N | N | N | 4.66E+06 | 5.45E+06 | 1.17 | A |
| 2-15 | — | Absent | N | N | N | N | 5.19E+06 | 6.38E+06 | 1.23 | A |
| 2-16 | — | Absent | N | N | N | N | 5.46E+06 | 6.77E+06 | 1.24 | A |
| 2-17 | — | Absent | N | N | N | N | 6.59E+06 | 8.17E+06 | 1.24 | A |
| 2-18 | — | Absent | N | N | N | N | 7.68E+06 | 9.75E+06 | 1.27 | A |
| 2-19 | — | Absent | N | N | N | N | 6.51E+06 | 8.27E+06 | 1.27 | A |
| 2-20 | — | Absent | N | N | N | N | 7.18E+06 | 8.83E+06 | 1.23 | A |
| 2-21 | — | Absent | N | N | N | N | 9.20E+06 | 1.15E+07 | 1.25 | A |
| 2-22 | — | Absent | N | N | N | N | 8.41E+06 | 1.06E+07 | 1.26 | A |
| 2-23 | — | Absent | N | N | N | N | 9.13E+06 | 1.12E+07 | 1.23 | A |
| 2-24 | — | Absent | N | N | N | N | 9.06E+06 | 1.16E+07 | 1.28 | A |
| 2-27 | — | Absent | N | N | N | N | 4,43E+07 | 5.54E+07 | 1.25 | A |
| 2-28 | — | Absent | N | N | N | N | 3.95E+07 | 5.02E+07 | 1.27 | A |
| 2-31 | — | Absent | N | N | N | N | 4.81E+07 | 6.06E+07 | 1.26 | A |
| 2-32 | — | Absent | N | N | N | N | 3.78E+07 | 5.07E+07 | 1.34 | 8 |
| 2-35 | — | Absent | N | N | N | N | 4.21E+07 | 5.39E+07 | 1.28 | A |
| 2-36 | — | Absent | N | N | N | N | 3.05E+07 | 3.93E+07 | 1.29 | A |
| — | 1-1 | Present | Y | Y | Y | Y | 5.42E+07 | 1.51E+08 | 2.79 | C |
| — | 2-1 | Absent | N | N | N | N | 8.52E+07 | 8.69E+08 | 10.2 | C |
| — | 2-2 | Absent | N | N | N | N | 3.19E+07 | 1.73E+08 | 5.42 | C |
| — | 2-3 | Absent | N | N | N | N | 2.87E+07 | 1.28E+08 | 4.45 | C |
| — | 2-5 | Absent | N | N | N | N | 2.65E+07 | 3.26E+08 | 12.3 | C |

In the table, IPN represents whether the IPN structure is present or not.

Further, “E+numeral” is the exponential notation of the numerical value. For example, “5.40E+05” represents “5.40×10⁵” (The same applies to the following). Further, in the columns of the formula (3) to formula (6), “Y” indicates that the formula in each column is satisfied, and “N” indicates that the formula in each column is not satisfied. Furthermore, in the table, Ex. represents Example and C. E. represents Comparative Example.

### Roller Resistance Value Variation Evaluation

For the measurement of the roller resistance value, a conductive roller that had been allowed to stand in 0° C. environment for 6 hours or more was used.

### Measurement of Initial Roller Resistance

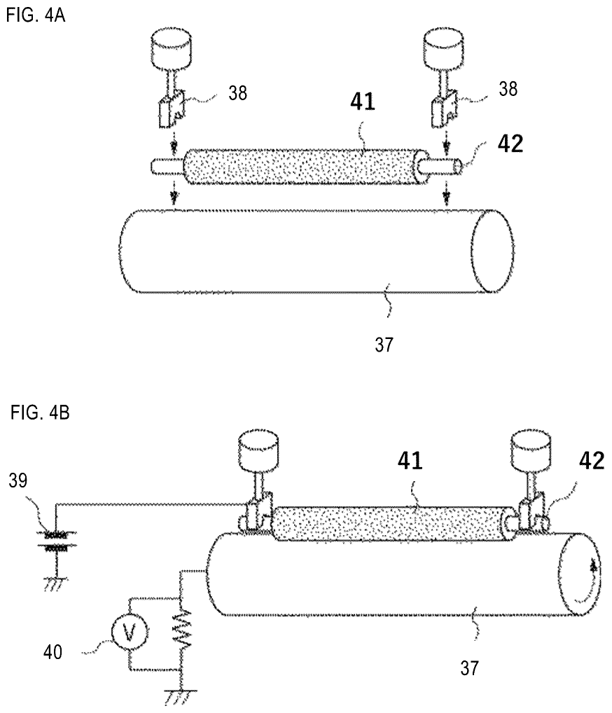

FIGS. 4A and 4B each show a schematic block view of a roller resistance value variation evaluating jig in accordance with the present disclosure. In FIG. 4A, under 0° C. environment, while pushing both ends of the conductive axial core body 42 via a conductive bearing 38 with a load of 4.9 N, respectively, a cylindrical metal 37 with a diameter of 24 mm was rotated at a surface speed of 50 mm/sec, thereby causing the conductive roller 41 to follow the rotation. Then, In FIG. 4B, a voltage of 50 V was applied by a high pressure power supply 39, and the potential difference between the both ends of a resistor having a known electric resistance (the one with a lower electric resistance by two orders of magnitude or more than the electric resistance of the conductive roller) provided between the cylindrical metal 37 and ground was measured. For the measurement of the potential difference, a voltmeter 40 (189TRUE RMS MULTIMETER manufactured by FLUKE Co.) was used. From the measured potential difference and the electric resistance of the resistor, the current flowed to the cylindrical metal 37 via the conductive roller 41 was determined. By dividing the applied voltage of 50 V by the obtained current, the electric resistance value of the conductive roller 41 was determined.

Herein, the measurement of the potential difference was performed in the following manner. Sampling was performed for 3 seconds from 2 seconds after application of the voltage, and the value calculated from the average value was referred to as the initial roller resistance value.

### Measurement of Roller Resistance After Evaluation

Immediately after performing ghost evaluation described alter, the roller was taken out, and the roller resistance after electrification was measured still under 0° C. environment.

### Electrification Deterioration

The value obtained by dividing the roller resistance value after evaluation by the initial roller resistance value (roller resistance value after evaluation/initial roller resistance value) was referred to as the indicator of the electrification deterioration.

### Ghost Evaluation

Then, the conductive roller whose initial roller resistance had been measured in the foregoing manner was allowed to stand in 0° C. environment for 6 hours or more. Then, the following evaluation was performed.

The laser printer having the configuration as shown in FIG. 3 (trade name, LBP7700C; manufactured by CANON CORP.) was set in 0° C. environment, and the conductive roller as the electrophotographic member of the present Example was mounted therein as a development roller, thereby performing evaluation of a ghost image.

Namely, using a black toner, as an image pattern, a 15-mm square solid black image was printed at the tip portion within one sheet, and then, an entirely half-tone image was printed. Then, the image density non-uniformity of the period of the development roller as the toner bearing member appearing at the half-tone portion was visually evaluated, and ghost evaluation was achieved by the following standards. Ghost Evaluation Under 0° C. Environment

A: any ghost is not observed at all.

B: a very slight ghost is observed.

C: a remarkable ghost is observed.

### Horizontal Streaks Image Evaluation

Then, the resulting electrophotographic members in accordance with Example 1-21 and Comparative Example 2-5 were subjected to the roller resistance value variation evaluation, and the evaluation regarding the following items was performed using these as charging rollers.

A change in conductivity (an increase in electric resistance) due to the electrification of the charging roller may generate image density non-uniformities (horizontal streaks) in minute streaks in a half-tone image. This is referred to as horizontal streaks image. The horizontal streaks image tends to be more generated as the conductivity of the charging roller changes, and tends to be more noticeable with long-term use of the electrophotographic apparatus. The electrophotographic member of the present disclosure was mounted in the electrophotographic apparatus as a charging roller, and the following evaluation was performed.

As the charging roller of the electrophotographic laser printer (trade name: HP Color Laserjet Enterprise CP4515dn manufactured by HP Co.) as an electrophotographic apparatus, each conductive roller obtained in Example 1-21 and Comparative Example 2-5 was mounted therein. Then, a durability test was performed in which images with a print density of 4% (images drawing horizontal lines with a width of 2 dots and an interval of 50 dots in the direction perpendicular to the rotation direction of the photosensitive member) were continuously outputted. Further, after continuously outputting 24000 images, half-tone images (images drawing horizontal lines with a width of 1 dot and an interval of 2 dots in the direction perpendicular to the rotation direction of the photosensitive member) were outputted for image check. The resulting images were visually observed, and the image density non-uniformities (horizontal streaks) in minute streaks were evaluated. The evaluation results are shown in Table 14.

A: Level at which any horizontal streaks are not generated at all.

B: Level at which horizontal streaks are slightly generated at only the image end.

C: Level at which horizontal streaks are generated at roughly half of the images, and are noticeable.

TABLE 14

| | | | | | | | Roller | | |
|---|---|---|---|---|---|---|---|---|---|
| | | | | Conductive | | Initial | resistance | | |
| | | | Elastic | layer | Impregnation | roller | after | | |
| | Comparative | Conducive | roller | forming | treatment | resistance | electrification | Electrification | Horizontal |
| Example | Example | roller No. | No. | paint No. | solution No. | (Ω) | (Ω) | deterioration | streaks |
| 3-1 | — | DG-1 | D′-2 | E′-1 | G-2 | 4.75E+05 | 5.80E+05 | 1.22 | A |
| — | 3-1 | DH-5 | D′-2 | EH-2 | — | 2.65E+07 | 3.26E+08 | 12.3 | C |

### Consideration of Evaluation Results

For the electrophotographic member manufactured in Example 3-1, the conductive layer in accordance with the present disclosure includes the first resin and the second resin in accordance with the present disclosure, and the second resin includes a (meth)acrylic resin having a prescribed structure. For this reason, an increase in the resistance after image output under 0° C. environment is less, and the image quality is also kept good.

In contrast, for Comparative Example 3-1 not including at least one of the first resin and the second resin in accordance with the present disclosure, an increase in resistance before and after image output under the environment is much, and a remarkable adverse effect is also generated in the image evaluation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-003873, filed Jan. 15, 2024, and Japanese Patent Application No. 2024-137910, filed Aug. 19, 2024 which are hereby incorporated by reference herein in their entirety.

What is claimed is:

1. An electrophotographic member comprising:
a conductive substrate; and
a conductive layer on the substrate, wherein
the conductive layer comprises a first resin and a second resin,
the first resin is a resin having at least one selected from the group consisting of a urethane bond, an ether bond, and an aromatic ring, and
the second resin comprises a (meth)acrylic resin having a structure expressed by a following formula (1), and a structure expressed by a following formula (2): 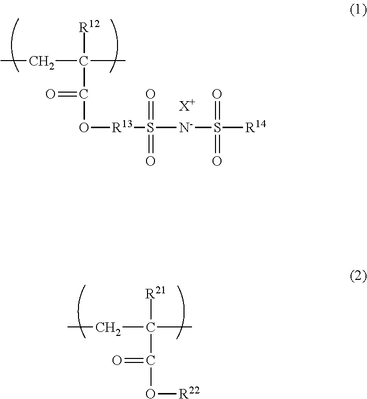
in the formula (1),
R¹² represents a hydrogen atom or a methyl group,
R¹³ represents a straight chain or branch alkylene group having 1 to 7 carbon atoms,
R¹⁴ represents
a fluorine atom or
a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms or an alicyclic hydrocarbon group having 5 to 6 carbon atoms.

2. The electrophotographic member according to claim 1, wherein
the conductive layer comprises a binder resin, and
the binder resin comprises the first resin.

3. The electrophotographic member according to claim 1, wherein
the first resin is at least one resin selected from the group consisting of polyurethane, polyether, and polyphenylene.

4. The electrophotographic member according to claim 1, wherein
the conductive layer comprises the first resin and the second resin in a first region up to 0.1 μm in a depth direction from an outer surface of the conductive layer.

5. The electrophotographic member according to claim 4, wherein
in the first region, the first resin and the second resin configure an interpenetrating polymer network structure.

6. The electrophotographic member according to claim 5, wherein
the first resin is polyurethane.

7. The electrophotographic member according to claim 5, wherein
T1 and T2 satisfy a relationship expressed by a following formula (3):
$$T 1 > T 2 \qquad ( 3 )$$
where T1 (° C.) represents a peak top temperature of a thermal chromatogram corresponding to the first resin in the first region, and
T2 (° C.) represents a peak top temperature of a thermal chromatograph corresponding to the first resin included in a second region with a thickness of 0.1 μm toward the outer surface from an inner surface of the conductive layer.

8. The electrophotographic member according to claim 7, wherein
T1 and T2 satisfy a following formula (4)
$$( T 1 - T 2 ) > 1. ( °C . ) \qquad ( 4 ) .$$

9. The electrophotographic member according to claim 1, wherein
a thickness of the conductive layer is 2.0 to 150.0 μm.

10. The electrophotographic member according to claim 5, wherein
T1, T2, and T3 satisfy a relationship expressed by a following formula (5) and a relationship expressed by a following formula (6):
$$T 1 > T 3 ; and \qquad ( 5 )$$
$$\vert T 1 - T 3 \vert > \vert T 3 - T 2 \vert \qquad ( 6 )$$
where T1 (° C.) represents a peak top temperature of a thermal chromatogram corresponding to the first resin in the first region,
T2 (° C.) represents a peak top temperature of a thermal chromatograph corresponding to the first resin included in a second region with a thickness of 0.1 μm toward the outer surface from an inner surface of the conductive layer, and
T3 (° C.) represents a peak top temperature of a thermal chromatogram corresponding to the first resin in a third region of from 1.0 to 1.1 μm in a depth direction from the outer surface of the conductive layer.

11. An electrophotographic process cartridge configured detachably with respect to a main body of an electrophotographic apparatus, the electrophotographic process cartridge comprising the electrophotographic member according to claim 1.

12. The electrophotographic process cartridge according to claim 11, comprising the electrophotographic member as a development member.

13. An electrophotographic image forming apparatus comprising a development member, wherein
the development member comprises
a conductive substrate; and
a conductive layer on the substrate,
the conductive layer comprises a first resin and a second resin,
the first resin is a resin having at least one selected from the group consisting of a urethane bond, an ether bond, and an aromatic ring, and
the second resin comprises a (meth)acrylic resin having a structure expressed by a following formula (1), and a structure expressed by a following formula (2): 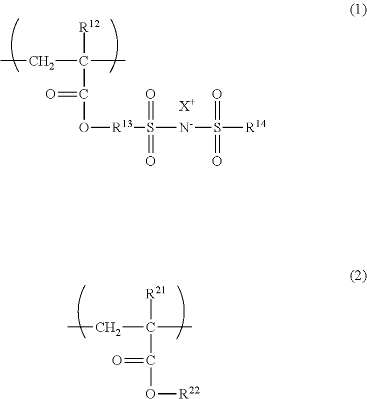
in the formula (1),
R¹² represents a hydrogen atom or a methyl group,
R¹³ represents a straight chain or branch alkylene group having 1 to 7 carbon atoms,
R¹⁴ represents
a fluorine atom or
a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms or an alicyclic hydrocarbon group having 5 to 6 carbon atoms.

14. An ionic conducting agent comprising a (meth)acrylic resin having a structure expressed by a following formula (1), and a structure expressed by a following formula (2): 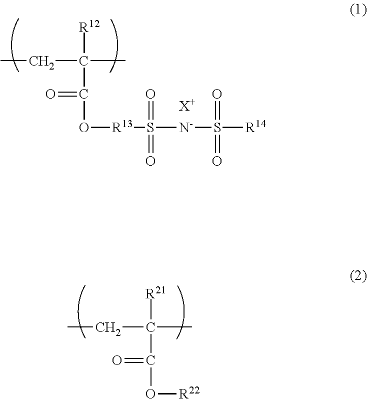
in the formula (1),
R¹² represents a hydrogen atom or a methyl group,
R¹³ represents a straight chain or branch alkylene group having 1 to 7 carbon atoms,
R¹⁴ represents a fluorine atom or
a straight chain or branch perfluoroalkyl group having 1 to 4 carbon atoms, and
X⁺ represents at least one selected from the group consisting of a lithium ion, a sodium ion, and a potassium ion; and
in the formula (2),
R²¹ represents a hydrogen atom or a methyl group, and
R²² represents a straight chain or branch alkyl group having 1 to 6 carbon atoms, or an alicyclic hydrocarbon group having 5 to 6 carbon atoms.
